(19) United States
(12) Patent Application Publication
(10) Pub. No.: US 2021/0090310 A1
(43) Pub. Date: Mar. 25, 2021

(54) EDITING DEVICE, EDITING METHOD, EDITING PROGRAM STORING MEDIUM, AND EDITING SYSTEM

(71) Applicant: Mitsubishi Electric Corporation, Tokyo (JP)

(72) Inventors: Reiko SAKATA, Tokyo (JP); Akiko IMAISHI, Tokyo (JP); Yoshimichi UMEKI, Tokyo (JP)

(73) Assignee: Mitsubishi Electric Corporation, Tokyo (JP)

(21) Appl. No.: 16/953,380

(22) Filed: Nov. 20, 2020

Related U.S. Application Data
(63) Continuation of application No. PCT/JP2018/025059, filed on Jul. 2, 2018.

(51) Int. Cl. G06T 11/60; G06F 3/0481; G06F 3/0482; G06F 3/0484

(52) U.S. Cl. CPC G06T 11/60; G06F 3/04845; G06F 3/0482; G06F 3/04817

(57) ABSTRACT

Included are: a display control unit for displaying a second image corresponding to a first image displayed by an output device and an editing component for editing the second image on an image editing screen; and an output control unit for generating an output image for the output device to display the first image on a basis of the second image edited using the editing component displayed by the display control unit, and outputting the output image to the output device.

### CROSS-REFERENCE TO RELATED APPLICATION

The present application is a bypass continuation of and claims priority to PCT/JP2018/025059, filed on Jul. 2, 2018, the entire contents of which are incorporated herein by reference.

### TECHNICAL FIELD

The present invention relates to an editing device, an editing method, and an editing program each for editing an image displayed by an output device, and an editing system including the editing device and the output device.

### BACKGROUND ART

Conventionally, output devices that display an image that can be visually recognized by a viewer is known.

For example, Patent Literature 1 discloses a vehicle planning support system in which a planned vehicle model generated on a display screen of a computer travels on a road in a three-dimensional virtual space and a driver's field of view is displayed as a simulation on a screen of a projector-type display device.

### CITATION LIST

### Patent Literature

Patent Literature 1: JP 2008-140138 A

### SUMMARY OF INVENTION

### Technical Problem

In conventional technology typified by the technology disclosed in Patent Literature 1, there is a disadvantage that it is impossible to edit an image in real time while the image as simulation display is being displayed by a projector-type display device as an output device.

The present invention has been devised to solve the above disadvantage, and an object of the invention is to provide an editing device capable of editing an image in real time while the image is being displayed by an output device.

### Solution to Problem

An editing device according to the present invention is an editing device for editing a first image in a state where an output device is displaying the first image, and includes: processing circuitry performing a process of: displaying a second image corresponding to the first image and an editing component for editing the second image on an image editing screen; and generating an output image for the output device to display the first image on a basis of the second image by following an operation using the editing component displayed, and when the output device receives information indicating a condition to start display of the first image and being determined by time upon editing the second image, starting outputting the output image to the output device in a case where the condition to start display of the first image is satisfied.

### Advantageous Effects of Invention

According to the present invention, it is possible to edit an image in real time while the image is being displayed by an output device.

### BRIEF DESCRIPTION OF DRAWINGS

FIG. 1A is a diagram illustrating an exemplary configuration of an editing system in a first embodiment.

FIG. 1B is a diagram illustrating another exemplary configuration of the editing system in the first embodiment.

FIG. 2 is a diagram illustrating an example of a first image displayed by a projector in the first embodiment.

FIGS. 3A, 3B and 3C are diagrams illustrating an example of the first image that is animated in the first embodiment.

FIG. 4 is a diagram illustrating a configuration example of an editing device according to the first embodiment.

FIG. 5 is a diagram for explaining an example of an image editing screen that is called by a user touching a display unit in the first embodiment.

FIG. 6 is a flowchart for explaining the operation of the editing device when a user edits the first image displayed by the projector using the editing device according to the first embodiment.

FIG. 7 is a diagram for explaining an example of information displayed in each area of the image editing screen in the first embodiment.

FIG. 8 is a diagram for explaining an example of an image selection screen in the first embodiment.

FIG. 9 is a diagram illustrating an exemplary concept of an editing operation of the size of a second image by a user touching with two fingers in the first embodiment.

FIG. 10 is a diagram illustrating an exemplary concept of an editing operation of the orientation of the second image by a user sliding one finger in the first embodiment.

FIG. 11 is a diagram illustrating a concept of an exemplary screen on which a display control unit displays editing components for editing the degree of an animation added to the second image in the first embodiment.

FIG. 12 is a diagram illustrating another exemplary concept of a screen on which the display control unit displays editing components for editing the degree of an animation added to a second image in the first embodiment.

FIG. 13 is a diagram illustrating an example of an animation setting screen displayed in an editing function display area in the first embodiment.

FIGS. 14A and 14B are diagrams illustrating exemplary hardware configurations of the editing device according to the first embodiment of the present invention.

FIG. 15 is a diagram illustrating a configuration example of an editing device according to a second embodiment.

FIG. 16 is a diagram illustrating an exemplary concept of an editing image display area in which a display control unit displays information based on editing guide information in the second embodiment.

FIG. 17 is a diagram illustrating another exemplary concept of the editing image display area in which the display control unit displays information based on editing guide information in the second embodiment.

FIG. 18 is a diagram illustrating a configuration example of an editing device according to a third embodiment.

FIGS. 19A and 19B are diagrams illustrating an example of an image in which, in the third embodiment, the output control unit displays a first image modified or rotated so that the first image is displayed in a preset size and orientation when viewed from a viewer.

FIG. 20 is a diagram illustrating a configuration example of an editing device according to a fourth embodiment.

FIGS. 21A and 21B are diagrams illustrating an example of an image in which, in the fourth embodiment, an output control unit displays a first image with the brightness or the color changed, of a case where there is no consideration to the environmental information, so that the first image having the same color and shape as those of a second image is displayed.

### DESCRIPTION OF EMBODIMENTS

Hereinafter, embodiments of the present invention will be described in detail with reference to the drawings.

### First Embodiment

An editing device is a device for a user to edit a first image displayed by an output device to cause a viewer to visually recognize the first image. In a first embodiment, an image indicating information for controlling the flow of people is assumed as the first image. The information indicated by the first image includes information such as, specifically, information indicating the type of an indoor facility, information indicating a direction of travel, information indicating an emergency evacuation guidance, information indicating prohibition of entry, or information indicating attributes of viewers such as sexes of viewers pertaining to control of the flow of people.

Note that the first image includes one or more characters, one or more character strings, one or more figures, one or more symbols, or one or more photographs. Each of these characters, character strings, figures, symbols, photographs, or the like is hereinafter also referred to as an “image component”. The mode of the first image may be a still image or a moving image.

In the following description, as an example, it is assumed that the editing device is mounted on a tablet-type personal computer (PC) (hereinafter referred to as “tablet PC”) including a touch panel. In addition, in the following description, as an example, it is assumed that the output device is a projector that projects an image onto an object using light. The projector projects a projection image onto an object. The projection image projected from the projector onto the object forms a first image on the surface of the object. At that time, the shape of the projection image is distorted depending on the shape of the surfaces, the position, etc. of the object. Therefore, the projection image is generated as such an image that allows the first image to be appropriately displayed on the object depending on the shape of the surfaces, the position, etc. of the object. Therefore, the projection image and the first image do not necessarily match in the shape, the size, or the like.

It is further assumed in the following description, as an example, that the object is a floor of a building having a projection surface on which the projection image is projected by the projector. Note that this is merely an example, and that the object may be a pillar, a wall, the ground, or the like, and includes any object having a surface on which the first image can be displayed by the projector projecting the projection image.

It is further assumed that the viewer is a person who is around the projector.

A user who uses the editing device 1 according to the first embodiment can edit the first image displayed on the floor by editing, by using a tablet PC, an image displayed on a display unit 101 (described later) included in the editing device 1 (hereinafter referred to as a “second image”) corresponding to the first image displayed on the floor by the projector. The editing device 1 generates an output image for the output device to display the first image on the basis of the second image edited by the user. The output image is for displaying the desired first image in a manner that the first image can be visually recognized by the viewer when the output device outputs the output image. For example, in a case where the output device is a projector, the editing device 1 generates a projection image to be projected by the projector as the output image. The editing device 1 outputs the generated projection image to the projector, and the projector projects the projection image onto the floor to display the first image on the floor.

The second image corresponding to the first image is displayed on the display unit included in the tablet PC when the user edits the first image using the tablet PC, and the user can freely edit the second image on the tablet PC while looking at the first image actually displayed on the floor, and reflect the edited content in real time in the first image displayed by the projector.

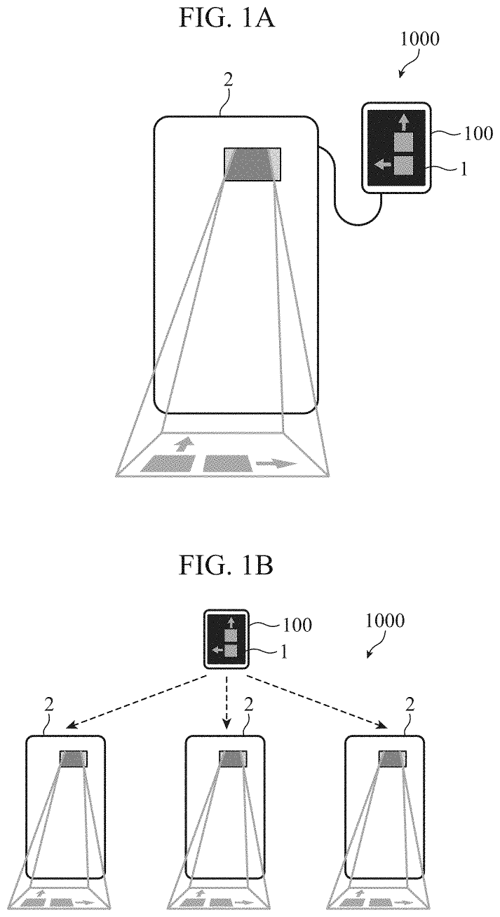

FIG. 1 is a diagram illustrating a configuration example of an editing system 1000 of the first embodiment. FIG. 1A is a diagram illustrating an exemplary configuration of the editing system 1000 according to the first embodiment, and illustrates an example in which one tablet PC 100 and one projector 2 are connected by wire in a communicable manner. FIG. 1B is a diagram illustrating another exemplary configuration of the editing system 1000 of the first embodiment, and illustrates an example in which the one tablet PC 100 and a plurality of projectors 2 are connected wirelessly in a selectively communicable manner.

The tablet PC 100 includes a display unit 101. The display unit 101 is a touch panel type display.

The user edits the second image by touching the display unit 101 with a finger, for example. The editing device 1 generates a projection image on the basis of the second image edited by the user touching the display unit 101 and outputs the projection image to the projector 2, and the projector 2 projects the projection image onto the floor.

The tablet PC 100 and a projector 2 are communicably connected to each other by some means regardless of whether in a wired or wireless manner.

In FIG. 1A, an example is illustrated in which one tablet PC 100 and one projector 2 are connected by wire in a communicable manner.

The tablet PC 100 and the projector 2 may be wirelessly communicably connected to each other using Wifi (registered trademark) communication, Bluetooth (registered trademark) communication, or the like. Moreover, one tablet PC 100 and a plurality of projectors 2 may be communicably connected.

In FIG. 1B, an example is illustrated in which one tablet PC 100 and three projectors 2 are connected wirelessly in a selectively communicable manner.

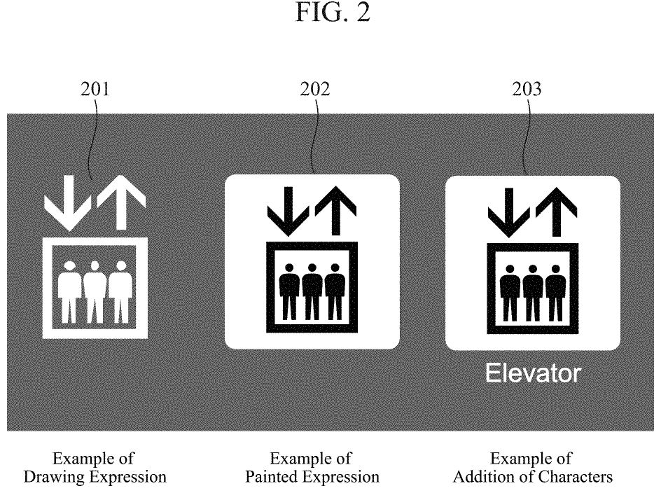

FIG. 2 is a diagram illustrating an example of the first image displayed by the projector 2 in the first embodiment.

FIG. 2 is a diagram illustrating images each illustrating an elevator as an example of the first image. The plurality of images illustrated in FIG. 2 are each an image illustrating an elevator, but are different from each other in the color of the lines and the background (see 201 and 202 in FIG. 2), or are different from each other in that whether only figures are included as image components or characters and a figure are combined (see 202 and 203 in FIG. 2).

Furthermore, in FIG. 2, an example of an image has been illustrated in which a figure indicating an elevator and characters indicating the elevator are combined as image components (see 203 in FIG. 2); however, the first image may be, for example, a combination of a figure indicating a certain place and a symbol such as an arrow.

It is also possible to add an animation to the first image to make the first image a moving image.

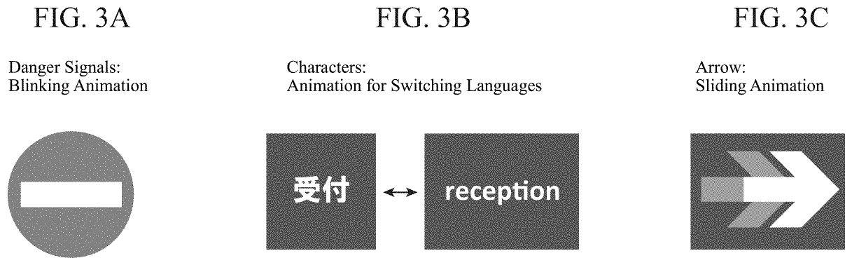

FIGS. 3A-3C are diagrams illustrating an example of the first image that is animated in the first embodiment. The animation may be, for example, a sliding animation, a blinking animation, or a language switching animation.

In FIG. 3A, an example of the first image is illustrated in which a blinking animation is added to a figure indicating a danger signal. In FIG. 3B, an example of the first image is illustrated in which a language switching animation is added to characters indicating “reception”. In FIG. 3C, an example of the first image is illustrated in which a figure indicating an arrow is added with a sliding animation.

When a blinking animation is added to an image component, the image component repeatedly turns on and off at a predetermined time interval. As for the predetermined time interval, for example, a cycle in which the image component completes one time of lights-on and one time of lights-off in one second (for example, the image component is lit for 0.5 sec., and then is turned off for 0.5 sec.) is set as the initial state. Note that the predetermined time interval may be editable by the user as appropriate. Note that, in FIG. 3A, a state in which the image component is blinking is illustrated.

When the language switching animation is added to the image component, the image component is switched from an expression in any one of multiple languages to an expression in another language at a predetermined time interval. As for the predetermined time interval and the order in which languages are switched, for example, a switching mode in which each language is sequentially displayed for two seconds is set as the initial state (for example, switching in the order of Chinese for two seconds ->Japanese for two seconds->Korean for two seconds). Note that the predetermined time interval may be editable by the user as appropriate. In addition, the order in which languages are switched may be editable by the user as appropriate. Note that, in FIG. 3B, an image component is illustrated in which an animation capable of switching between Japanese characters and English characters is added as the characters indicating “reception”. The left side of FIG. 3B is the image component expressed in Japanese, the right side is the image component expressed in English, and these image components are switched at a predetermined time interval.

When a sliding animation is added to an image component, the image component repeats the operation of moving from a predetermined start point in an area where a first image is displayed toward a predetermined end point and, after moving to the end point, moving from the start point again toward the end point. Regarding the time interval in which the image component repeats the operation, for example, a cycle in which one sliding animation completes from the start to the end in one second (for example, the image component moves from the start point to the end point in one second) is set as the initial state. Meanwhile, a time interval in which the image component repeats the operation may be edited by the user as appropriate. Note that the image component is a figure illustrating an arrow in FIG. 3C and that two arrows are illustrated to represent the movement of the arrow; however, in reality, the two arrows are not necessarily displayed simultaneously.

As illustrated with FIGS. 2 and 3, a first image or an image component of the first image may be displayed by the projector 2 in various modes.

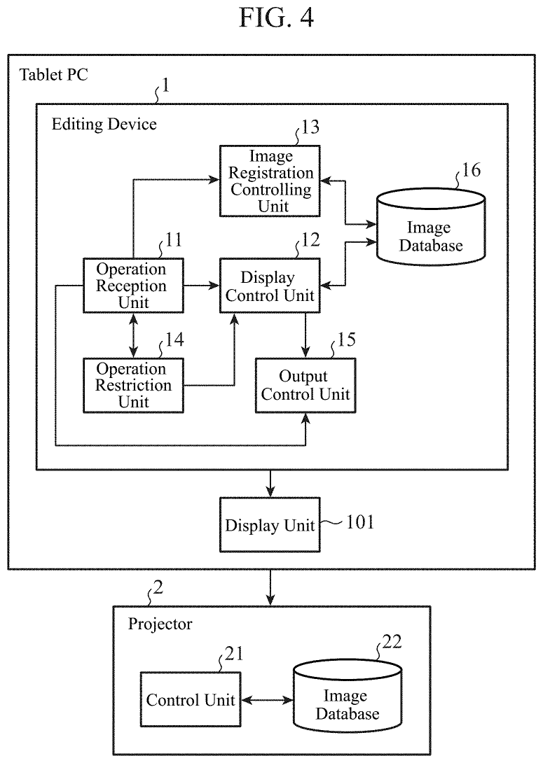

FIG. 4 is a diagram illustrating a configuration example of the editing device 1 according to the first embodiment. In FIG. 4, a configuration example of the projector 2 is also illustrated which is communicatively connected with the editing device 1 according to the first embodiment.

The editing device 1 includes an operation reception unit 11, a display control unit 12, an image registration controlling unit 13, an operation restriction unit 14, an output control unit 15, and an image database 16.

The operation reception unit 11 receives various types of information corresponding to the operations on the basis of various operations performed by a user. Hereinafter, for example, in a case where it is described that “the operation reception unit 11 receives an operation”, it means that the operation reception unit 11 receives various types of information corresponding to the operation.

For example, the operation reception unit 11 receives a call operation of an image editing screen input by the user touching the display unit 101. For example, when the user intends to edit the first image displayed on the floor by the projector 2, the user touches the image editing screen call button displayed on the display unit 101 to perform a call operation of the image editing screen and thereby calls the image editing screen.

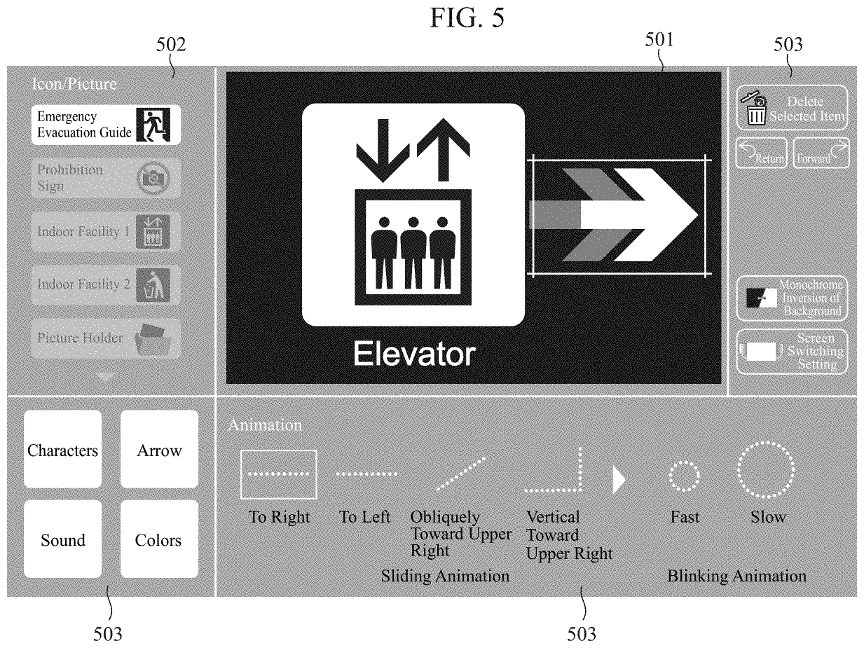

Here, FIG. 5 is a diagram for explaining an exemplary concept of an image editing screen that is called by a user touching the display unit 101 in the first embodiment.

The image editing screen includes an editing image display area 501, an image list display area 502, and editing function display areas 503.

The editing image display area 501 is an area in which a second image corresponding to the first image displayed on the floor by the projector 2 is displayed.

The image list display area 502 is an area in which various image components stored in the image database 16 are displayed as a list. For example, the user creates in advance a plurality of types of figures as image components, and stores the figures in the image database 16, for each of classifications of the figures, together with a name that identifies the classification of the figures. Alternatively, for example, the user obtains a plurality of types of photograph data as image components in advance, and stores the photograph data in the image database 16. In the example illustrated in FIG. 5, in the image list display area 502, icon figure classifications and names thereof and photograph folders are displayed as a list on the basis of the data stored in the image database 16.

An editing function display area 503 is an area in which various editing functions used for editing the second image are displayed. Various editing functions include, specifically, for example, a function for calling a screen such as a character input screen or an animation setting screen in order to edit the second image, or a function for selecting the type of characters to be displayed or the type of an animation to be added to an image component.

The image list display area 502 and the editing function display areas 503 are editing components. The editing components are various components displayed on the image editing screen in order to edit the second image displayed in the editing image display area 501. In other words, the editing components are the content displayed on the image editing screen other than the second image corresponding to the first image. In addition to the image list display area 502 and the editing function display area 503, the editing components include various contents such as an image list display screen, operation buttons for designating the degree of sliding animation, a frame, a color chart, or a brightness adjustment screen, which will be described later.

Note that the arrangement of the areas illustrated in FIG. 5 is merely an example, and it is sufficient that at least the editing image display area 501 is included in the image editing screen. Furthermore, for example, in a case where the image editing screen includes an editing image display area 501, an image list display area 502, and an editing function display area 503, it is desirable that the editing image display area 501 is larger than the image list display area 502 and the editing function display area 503.

The user can edit the first image displayed by the projector 2 in real time by calling the image editing screen as illustrated in FIG. 5 and editing the second image on the image editing screen.

The operation reception unit 11 receives, in addition to the call operation of the image editing screen, call operations of various screens input by the user operating the display unit 101. The operation reception unit 11 outputs information of the received call operation of various screens to the display control unit 12.

Moreover, for example, regarding the second image displayed in the editing image display area 501, the operation reception unit 11 receives, from the user, a selection operation of each image component to be included in the second image. The user selects an image component to be edited by touching an image component to be edited among the image components included in an editing image displayed on the display unit 101. The operation reception unit 11 receives information for specifying the image components selected by the user. The operation reception unit 11 outputs information for specifying the received image components to the display control unit 12.

Furthermore, for example, the operation reception unit 11 receives the editing operation performed on the image components selected by the user among the image components included in the second image displayed in the editing image display area 501 of the image editing screen, and outputs attribute information of the edited image components to the display control unit 12.

The user causes the second image to be displayed in the editing image display area 501, selects a desired image component by operating the display unit 101, and performs an editing operation of the image component such as editing the position of the image component, editing the shape including the size or the orientation of the image component, editing the color of the image component, editing the brightness of the image component, editing an animation added to the image component, deleting the image component, or adding the image component. The operation reception unit 11 receives an editing operation performed by the user on each image component. With regards to the second image displayed in the editing image display area 501 after the user has edited each image component, the operation reception unit 11 outputs attribute information of each of the image components included in the second image to the display control unit 12. The attribute information is related to each of the image components included in the second image displayed in the editing image display area 501, and indicates, for example, the position, the shape, the color, the brightness, or an added animation of the image component.

The display control unit 12 controls the display of various types of information on the display unit 101.

For example, the display control unit 12 causes the display unit 101 to display various screens on the basis of information of a screen call operation information output from the operation reception unit 11. For example, in a case where the operation reception unit 11 outputs information of a call operation of the image editing screen, the display control unit 12 causes the display unit 101 to display the image editing screen as illustrated in FIG. 5.

Furthermore, for example, the display control unit 12 causes editing components to be displayed which are used for editing the second image. Their details will be described later.

Further, for example, the display control unit 12 causes the display unit 101 to display the second image in the editing image display area 501 on the basis of the information for specifying the image component selected by the user, which is output from the operation reception unit 11, and the attribute information of the image component.

The display control unit 12 further outputs the information of the second image displayed in the editing image display area 501 to the output control unit 15. Specifically, the display control unit 12 outputs, to the output control unit 15, for example, the information for specifying each of the image components included in the second image displayed in the editing image display area 501 and attribute information of each of the image components.

When a new image component is created by the user's operation, the image registration controlling unit 13 adds the newly created image component to the image database 16 on the basis of information of the registration operation of the image component from the operation reception unit 11.

Note that it is not necessary that the editing device 1 has a function of adding a new image component to the image database 16.

The operation restriction unit 14 restricts the operation of the operation reception unit 11 depending on an editing operation received by the operation reception unit 11.

Specifically, for example, in a case where the user performs an editing operation to move a certain image component from the current display position to a position outside the editing image display area 501 in order to delete the certain image component in the second image, the operation restriction unit 14 temporarily places restrictions so that the operation reception unit 11 does not receive any further editing operation to move the image component once the image component has been moved to the end of the editing image display area 501. Note that, in a case of deleting an image component in the second image, the user can move the image component to the outside of the editing image display area 501 and delete the image component by touching the image component displayed in the editing image display area 501 with a finger and sliding the finger to the outside of the editing image display area 501. With respect to editing operations such as deleting an image component, the operation restriction unit 14 can prevent deletion of an image component due to an erroneous operation by the user by temporarily restricting the reception of editing operations by the operation reception unit 11 as described above.

Furthermore, for example, in a case where the operation reception unit 11 determines that it is difficult to determine whether the point touched on the display unit 101 by the user with (a) finger(s) is one or two points are detected, the operation restriction unit 14 causes the operation reception unit 11 to cancel reception of the editing operation by the touch. Alternatively, in similar cases, the operation restriction unit 14 causes the operation reception unit 11 to receive the editing operation by the touch by regarding the point touched by the user on the display unit 101 as one point. Note that the operation reception unit 11 determines whether it is difficult to detect the touched point on the basis of the area where the touch has been detected, and outputs the determination result to the operation restriction unit 14. When it is difficult to determine the number of touch points, the operation restriction unit 14 can prevent the user's erroneous operation by restricting the reception of the editing operation as described above or by receiving the editing operation as a simpler operation.

In a case where the operation reception by the operation reception unit 11 is restricted, the operation restriction unit 14 outputs, to the display control unit 12, information indicating that the operation reception is being restricted.

The output control unit 15 causes the projector 2 to display the first image.

Specifically, the output control unit 15 generates a projection image that allows the first image, corresponding to the second image, to be displayed on an object so as to be visually recognizable by a viewer on the basis of the shape of the surfaces, the position, etc. of the object on which the first image is displayed and the edited second image. The shape of the surfaces, the position, etc. of the object on which the first image is displayed are acquired in advance when the projector 2 is installed, and is stored in an appropriate storage device (not illustrated) which the editing device 1 can refer to.

The output control unit 15 outputs the generated projection image to the projector 2 and causes the projector 2 to execute the projection of the projection image on a floor. When the projector 2 projects the projection image on the floor, the first image that has a similar shape to that of the second image and is visually recognizable by a viewer is displayed on the floor.

The editing components displayed in the editing image display area 501 are not used when the output control unit 15 generates the projection image. Therefore, the editing components displayed on the image editing screen are not displayed when the output control unit 15 causes the projector 2 to display the first image.

Furthermore, when the output control unit 15 receives a registration operation of the second image to the projector 2 from the operation reception unit 11, the output control unit 15 may output, to the projector 2, the information for specifying each of the image components included in the second image displayed in the editing image display area 501 and the attribute information of each of the image components. When receiving a registration operation of the second image to the projector 2, the operation reception unit 11 may also receive a name specifying the second image to be registered, and output information indicating the name to the projector 2. The name can be input by the user operating the display unit 101.

The operation reception unit 11 may receive information indicating a condition for the projector 2 to start displaying the first image based on the second image (hereinafter referred to as a “display trigger”) when receiving a registration operation of the second image to the projector 2, and may output information indicating the display trigger to the projector 2.

An example of the display trigger is one in which time or a date is used as a condition. For example, the display trigger is set as a condition such that the projector 2 starts displaying a certain first image when the time reaches midnight and that the projector 2 displays another first image when the time reaches noon. Alternatively, for example, a display trigger may be set as a condition such that the projector 2 starts displaying a certain first image when the date reaches a first date and that the projector 2 displays another first image when the date reaches a second date.

Another example of display triggers is one in which operation information of a facility in a building is used as a condition. A facility in a building may be, for example, a security gate, an elevator, an escalator, or a station platform fence. For example, a display trigger can be set as a condition in which the projector 2 starts displaying a first image with a blinking animation indicating a warning when a security gate detects a situation with a security problem. Further alternatively, for example, a display trigger may be set as a condition such that, immediately before a cabin of an elevator arrives at the floor where the projector 2 is installed while the projector 2 is displaying a first image, the projector 2 starts displaying another first image having a display direction different from that of the first image. As another example, a display trigger may be set as a condition such that, in a case of an escalator that slows down or stops when there are no people around, the projector 2 starts displaying a first image in which the animation speed is changed for an arrow, which indicates whether the escalator is going up or down and is displayed as the first image. As still another example, a display trigger may be set as a condition such that the projector 2 starts displaying a first image indicating an appropriate stop position for a train or an appropriate position for a station platform door to open and to close depending on operation information of trains.

Yet another example of a display trigger is one that is conditional on information from a building management system. The information from a building management system is, for example, information from a sensor installed in a building or information from a surveillance camera installed in the building. For example, a display trigger may be set as a condition for the projector 2 to start displaying the first image indicating an appropriate guidance direction for a flow of people depending on the congestion state of people detected by the building management system. Alternatively, for example, a display trigger may be set as a condition for the projector 2 to start displaying a first image indicating an appropriate area division of passages depending on the attribute of people detected by the building management system.

Still yet another example of a display trigger is one that is conditional on information obtained from a personal authentication medium. A personal authentication medium may be a smartphone, a card, or the like owned by an individual. For example, a display trigger may be set as a condition such that, when information of a room card held by a certain user is acquired by an appropriate reading device or the like in a hotel, the projector 2 starts displaying a first image indicating a route for guiding the user to the room according to the information. As another example, a display trigger may be set as a condition such that the projector 2 starts displaying a first image in which characters are displayed in a language that corresponds to the nationality of a user holding a personal authentication medium when information indicating the nationality of the user is acquired from the medium.

Still another example of a display trigger is one that is conditional on a distance between a person who is a target of displaying the display by the projector 2 and the projector 2. For example, a display trigger may be set as a condition such that the projector 2 starts displaying a first image having an appropriate aspect ratio or size depending on a distance between the projector 2 and a person who is a target of the display by the projector 2.

When the projector 2 receives information specifying image components included in a second image, attribute information of each of the image components, information indicating the name of the second image, or information indicating a display trigger that are output from the output control unit 15 with respect to the second image to be registered, a control unit 21 included in the projector 2 (described later, hereinafter referred to as the “projector control unit 21”) associates these pieces of information with a projection image based on the second image and registers the projection image in the image database 22 included in the projector 2 (described later, hereinafter referred to as the “projector-side image database 22”).

As illustrated in FIG. 1B, in a case where a plurality of projectors 2 is selectively connectable to a single tablet PC 100, the tablet PC 100 is connected to one or more projectors 2 among the plurality of projectors 2 in order to edit a first image displayed by the one or more projectors 2. In this case, the projector 2 that is not connected to the tablet PC 100 cannot acquire, for example, a projection image based on the edited second image from the tablet PC 100. However, if various types of information such as the information of the second image output from the output control unit 15 is registered in the projector-side image database 22 as described above, each of the projectors 2 can display the first image corresponding to the second image on the basis of various types of information registered in the projector-side image database 22 even in a state where each of the projectors 2 is not connected to the tablet PC 100. Moreover, if various types of information output from the output control unit 15 are registered in the projector-side image database 22 as described above, communicatively connecting the tablet PC 100 with a desired projector 2 allows a user to call the information of the second image registered in the projector-side image database 22 by operating the display unit 101 and then to edit the first image displayed by the projector 2. Furthermore, if various types of information output from the output control unit 15 are registered in the projector-side image database 22 as described above, the user can connect the tablet PC 100 with a certain projector 2 in a communicable manner and call the information of the second image and then connect the tablet PC 100 with other projectors 2 in a communicable manner to cause the other projectors 2 to display the first image on the basis of the information of the second image.

The image database 16 stores image components. The image database 16 stores image components, for example, in a hierarchical structure for each preset classification and also stores the name of each classification. In the first embodiment, as illustrated in FIG. 4, the image database 16 is included in the editing device 1; however, without limiting thereto, the image database 16 may be provided outside the editing device 1 at a place where the editing device 1 can refer to.

The projector 2 includes the projector control unit 21 and the projector-side image database 22.

The projector control unit 21 controls all functions of the projector 2. For example, the projector control unit 21 causes a projection unit (not illustrated) included in the projector 2 to project a projection image when the projector control unit 21 acquires the projection image output from the editing device 1. In addition, for example, when the projector control unit 21 receives an instruction including the name of the second image which is input by the user using an operation unit (not illustrated), the projector control unit 21 acquires a projection image associated with the name of the second image from the projector-side image database 22 and causes the aforementioned projection unit to project the projection image. In addition, when the projector control unit 21 receives information specifying image components included in a second image to be registered, attribute information of each of the image components, information indicating the name of the second image, or information indicating a display trigger from the output control unit 15, the projector control unit 21 associates these pieces of information with a projection image based on the second image and registers the projection image in the projector-side image database 22.

The projector-side image database 22 stores information specifying image components included in a second image to be registered, attribute information of each of the image components, information indicating the name of the second image, information indicating a display trigger, or a projection image based on the second image.

Next, description will be given on the specific operation of the editing device 1 when a user edits a first image displayed by the projector 2 using the editing device 1 according to the first embodiment.

Note that it is assumed in the following description as an example that the first image is an image in which a figure indicating restrooms and a figure illustrating an arrow are combined as image components.

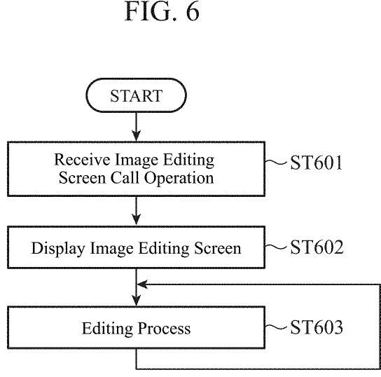

FIG. 6 is a flowchart for explaining the operation of the editing device 1 when a user edits a first image displayed by the projector 2 using the editing device 1 according to the first embodiment.

The operation reception unit 11 receives a call operation of the image editing screen (step ST601). Specifically, for example, the user touches the display unit 101 with a finger to perform a call operation of the image editing screen. That is, the call operation of the image editing screen is an editing start instruction for starting editing of the first image displayed on a floor by the projector 2. The operation reception unit 11 receives the call operation input by the user.

The operation reception unit 11 outputs information of the received call operation of the image editing screen to the display control unit 12.

The display control unit 12 causes the display unit 101 to display the image editing screen (step ST602).

The editing device 1 performs an editing process of editing the second image on the basis of the operation of the display unit 101 by the user (step ST603).

(1) Adding an Image Component

In the editing process of step ST603, first, a user operates the display unit 101 to cause the projector 2 to display the first image. That is, the editing device 1 causes the projector to display the first image on the basis of the operation of the display unit 101 by the user.

In the editing process, specifically, the user edits the second image on the image editing screen by, for example, touching the display unit 101, and the editing device 1 causes the projector 2 to display the first image corresponding to the edited second image. Their details will be described below.

In the following description, it is assumed as an example that the user edits a blank second image with no image components to create a new second image in which a figure indicating a restroom (hereinafter referred to as a “restroom icon”) and a figure illustrating an arrow (hereinafter referred to as an “arrow figure”) are combined, and causes the projector 2 to display a first image corresponding to the second image.

The operation reception unit 11 receives selection of an image component, and the display control unit 12 displays the received image component in the editing image display area 501. Specifically, for example, the user touches the display unit 101 with a finger to select an image component to be included in the first image to be displayed by the projector 2.

There are several methods for a user to select an image component.

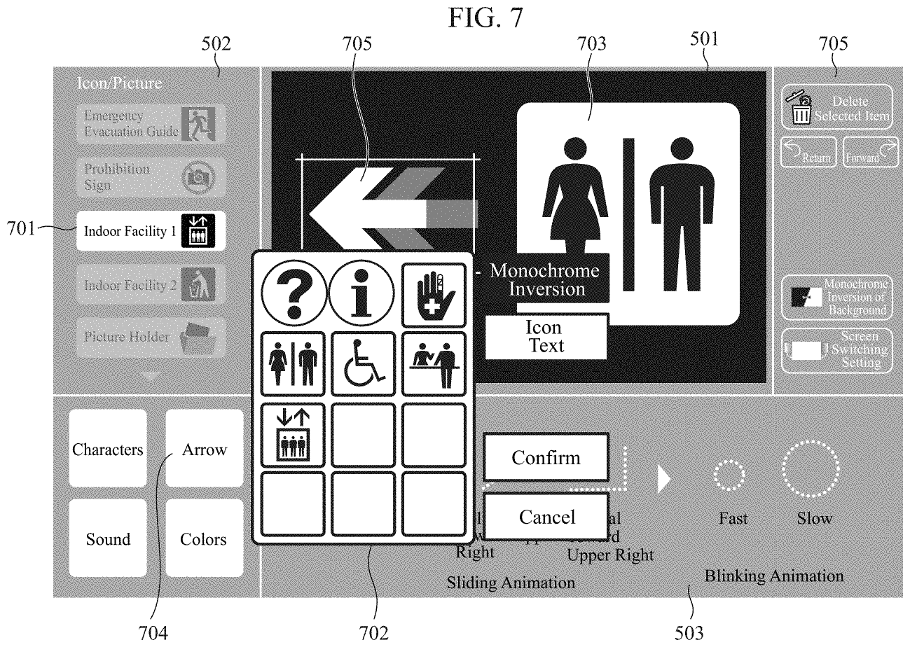

For example, the user performs an adding operation of an image component by touching an “add” button (not illustrated) displayed on the image editing screen. The operation reception unit 11 receives the adding operation of the image component, and outputs information of the received adding operation of the image component to the display control unit 12. The display control unit 12 displays, in the image list display area 502 on the image editing screen, image components included in each classification on the basis of classes of a plurality of types of image components stored in the image database 16 (see 701 in FIG. 7). The user can select a classification to which the restroom icon belongs to by confirming the displayed image list display area 502 and touching the desired classification with a finger. The operation reception unit 11 receives the selecting operation of the classification and outputs information specifying the received classification to the display control unit 12. The display control unit 12 displays an image list display screen (see 702 in FIG. 7), in which a list of image components included in the classification output from the operation reception unit 11 is displayed, on the image editing screen in a superimposed manner. The user touches the restroom icon with a finger to select the icon from the displayed list of image components, and slides the touching finger to move the restroom icon to the editing image display area 501. The operation reception unit 11 receives a sliding operation of moving the restroom icon by the user, and the display control unit 12 displays the restroom icon in the editing image display area 501 depending on the sliding operation (see 703 in FIG. 7). The user further selects an arrow figure by touching an “arrow” button (see 704 in FIG. 7) displayed in the editing function display area 503. The operation reception unit 11 receives the selection of the arrow figure, and the display control unit 12 displays the arrow figure in the editing image display area 501 (see 705 in FIG. 7). Note that the display control unit 12 displays the arrow figure at an appropriate position in the editing image display area 501, for example. Specifically, for example, the user touches the arrow figure and slides the touching finger to a desirable position in the editing image display area 501. The operation reception unit 11 receives the sliding operation and outputs the sliding operation to the display control unit 12. The display control unit 12 displays the arrow figure at the position where the user has finished the sliding operation in the editing image display area 501 (see 705 in FIG. 7). Note that, in FIG. 7, the arrow figure is added with a sliding animation. At this time, the image list display screen and operation buttons for designating the degree of the sliding animation displayed on the image editing screen are editing components.

In this manner, the user adds image components to the second image and displays the image components in the editing image display area 501.

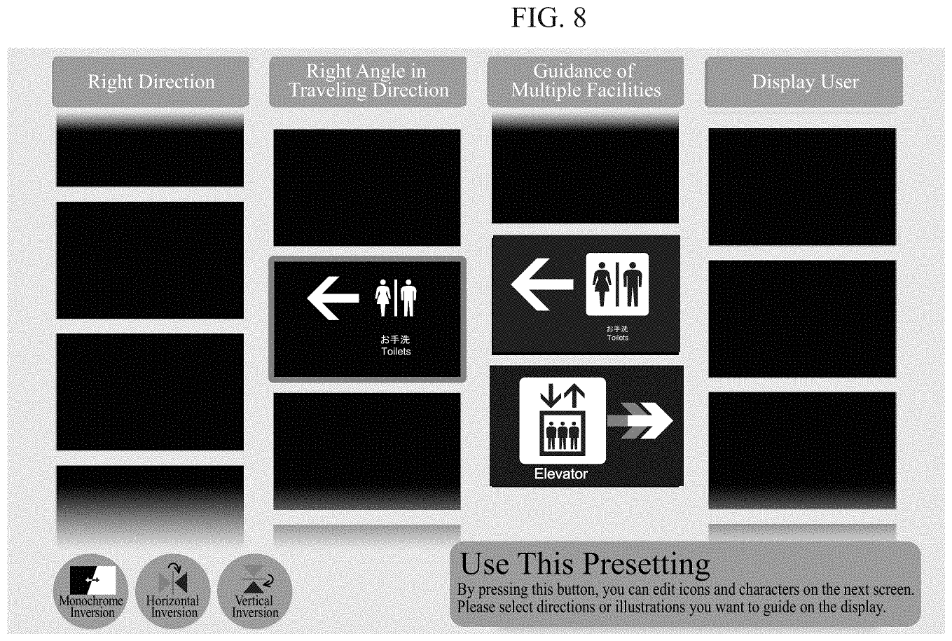

Furthermore, for example, the user may input a call instruction for the image selection screen as illustrated in FIG. 8 from the image editing screen and switch to the image selection screen for display. Specifically, for example, the user performs a call operation of the image selection screen by touching an image selection screen call instruction (not illustrated) displayed on the image editing screen. The operation reception unit 11 receives a call operation of the image selection screen, and the display control unit 12 switches the display to the image selection screen. On the image selection screen, an image including a combination of preset image components is displayed. These preset images are stored in, for example, the image database 16. Specifically, for example, as illustrated in FIG. 8, an image in which the restroom icon and the arrow figure are combined is displayed. The user touches and selects a desired image (here, an image in which the restroom icon and the arrow figure are combined) from the image selection screen, and the operation reception unit 11 receives the selected image. Then, the display control unit 12 displays the selected image as a second image at an appropriate position in the editing image display area 501 of the image editing screen. At this time, the display control unit 12 switches from the image selection screen to the image editing screen again.

In this manner, the user can select an existing second image from the image selection screen and display the second image on the editing image display area 501.

Furthermore, for example, the user can freely create an image component by tracing with a finger in the editing image display area 501 on the image editing screen and add the image component to a second image. Specifically, the user traces with a finger in the editing image display area 501 to draw an image component including a restroom icon and an arrow figure.

Here, the image components are figures; however, an image component may be a character string, and the user can also input the image component as a character string by a keyboard operation or a voice input operation, for example Specifically, the user performs a call operation for the keyboard screen, and the display control unit 12 displays the keyboard screen. The user touches the keyboard screen to input a character string, and the operation reception unit 11 receives the input character string. For example, the maximum number of characters that can be input may be set in advance. For example, the editing device 1 may include a translation unit (not illustrated) having a translation function supporting multiple languages. The translation unit may translate an input character string into another language, and the display control unit 12 may additionally display the translated character string in the editing image display area 501.

Alternatively, for example, the user can create an image component including a character string based on voice information by inputting voice into a microphone (not illustrated) included in the editing device 1. Also in this case, the translation unit may translate the voice information based on the input voice into another language, and the display control unit 12 may additionally display the character string based on the translated voice information in the editing image display area 501.

In this manner, the user can add an image component created by an appropriate method to a second image. In addition, in a case where a new image component is created, the user can also register the newly created image component in the image database 16. Specifically, the user performs a registration operation by touching a “register” button (not illustrated) displayed on the image editing screen. The operation reception unit 11 receives the registration operation and outputs the image component to the image registration controlling unit 13. The image registration controlling unit 13 registers the image component newly added to the editing image display area 501 in the image database 16. Note that, for example, the user inputs also the classification of the image component when performing the registration operation and that the image registration controlling unit 13 adds the image component to the input classification when adding the image component. In a case where a character string input from the keyboard or a character string based on the voice information is translated to create an image component as described above, the user can also register the character string before translation as an image component in the image database 16.

The display control unit 12 further outputs the information of the second image displayed in the editing image display area 501 to the output control unit 15.

The output control unit 15 generates a projection image that allows the first image, corresponding to the second image, to be displayed on an object so as to be visually recognizable by a viewer on the basis of the second image output from the display control unit 12. The output control unit 15 outputs the generated projection image to the projector 2 and causes the projector 2 to execute the projection of the projection image on a floor. When the projector 2 projects the projection image on the floor, the first image that has a similar shape to that of the second image and is visually recognizable by a viewer is displayed on the floor.

The editing components displayed on the image editing screen are not used when the output control unit 15 generates the projection image. Therefore, the editing components displayed on the image editing screen are not displayed when the output control unit 15 causes the projector 2 to display the first image. That is, the image list display screen and the like are not displayed on the floor.

As a result, the first image is displayed on the object by the projector 2 on the basis of the second image edited by the user on the tablet PC 100.

By the operation described in “(1) Adding an image component”, the user edits the second image displayed in the editing image display area 501 on the image editing screen as appropriate while the projector 2 is displaying the first image. Specifically, the user touches the image editing screen to select one of the image components included in the second image, and edits the image component. The operation reception unit 11 receives the selection of the image component and the editing operation of the selected image component, outputs attribute information of the edited image component to the display control unit 12, and the display control unit 12 displays a second image including the edited image components in the editing image display area 501. At this time, the display control unit 12 superimposes and displays the editing components on the image components.

The display control unit 12 further displays the second image in the editing image display area 501 and outputs information of the second image to the output control unit 15. The output control unit 15 generates a projection image on the basis of the second image, outputs the generated projection image to the projector 2, and causes the projector 2 to project the projection image on the floor. By causing the projector 2 to project the projection image, the editing content on which an instruction is given by the user is reflected in the first image displayed on the object by the projector 2. Hereinafter, some examples will be described.

Note that, when the user operates the display unit 101 to start editing the second image, the editing device 1 causes the projector 2 to keep displaying the first image based on the edited second image at all times.

(2) Editing the Shape of an Image Component

A user can edit the shape including the size and the orientation of each of the image components included in the second image displayed in the editing image display area 501 on the image editing screen. The user edits an image component included in the second image on the image editing screen to reflect the edited content in the first image.

Specifically, the user first touches and selects an image component to be edited among the image components included in the second image displayed in the editing image display area 501. For example, the user selects the restroom icon from the restroom icon and the arrow figure. The user selects an image component by, for example, touching the vicinity of the center of the image component with one finger. In the first embodiment, the vicinity of the center of an image component refers to, for example, within a range of approximately 50% of the area of the entire image component including the center point of the image component. The vicinity of the center of the image component may be set in a circle from the center point of the image component, for example.

Alternatively, the editing device 1 may be configured to enable a user to select an image component by, for example, touching the vicinity of the center of the image component with one finger and an end of the image component with another finger.

The operation reception unit 11 receives the selection of the image component and outputs information for specifying the selected image component to the display control unit 12. When the information specifying the selected image component is output, the display control unit 12 displays a frame around the selected image component. The frame is an editing component. The display control unit 12 displays the image component and the frame in a superimposed manner. For example, supposing that the operation reception unit 11 receives selection of the restroom icon, the display control unit 12 displays a frame around the restroom icon in a superimposed manner.

With the frame displayed by the display control unit 12, the user can instantly grasp which image component is to be edited without staring at the display.

The user selects an image component and, for example, edits the size of the image component.

Specifically, for example, in a case where the user selects an image component by touching with two fingers, the user enlarges the size of the image component by spreading the two touching fingers. Conversely, for example, the user reduces the size of the image component by narrowing the two touching fingers.

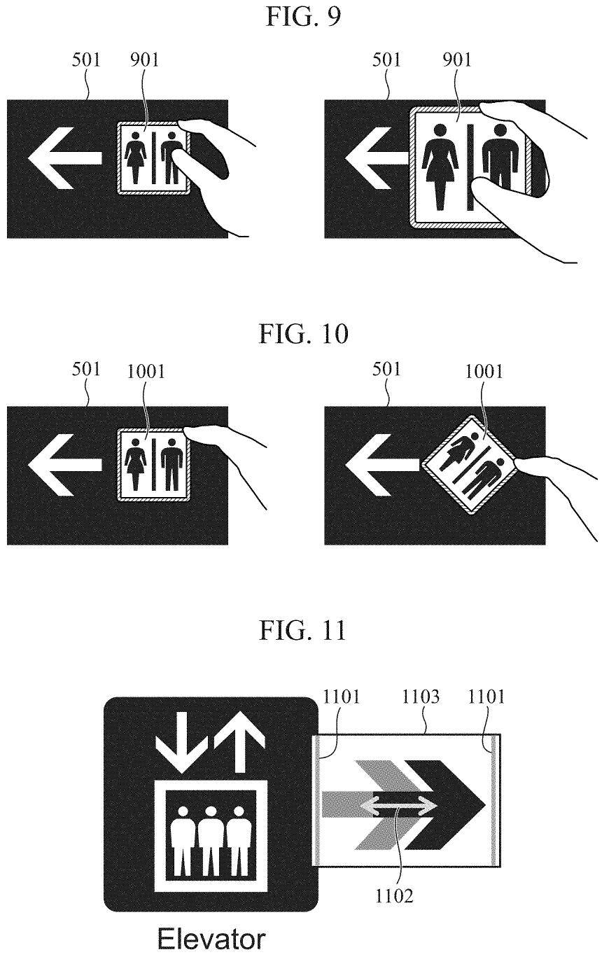

FIG. 9 is a diagram illustrating an exemplary concept of an operation editing the size of an image component by a user touching with two fingers in the first embodiment. Note that, in FIG. 9, a frame, which indicates that the image component is being selected, is denoted by 901.

The operation reception unit 11 outputs, to the display control unit 12, attribute information of the image component the size of which has been edited. The display control unit 12 increases or reduces the size of the image component displayed in the editing image display area 501 on the basis of the attribute information, and outputs information of the second image after the size of the image component has been edited to the output control unit 15.

The output control unit 15 causes the projector 2 to display the first image on the basis of the information of the edited second image output from the display control unit 12. However, the output control unit 15 does not project the editing components. That is, the frame 901 is not projected.

As a result, the first image displayed on the object by the projector 2 is edited in real time. This also prevents the first image from becoming hard to see for viewers or the like since the editing components, which are not necessary for the viewers who view the first image and the user who is editing while viewing the first image, are not displayed by the projector 2.

In addition, when the user selects an image component, the user can edit, for example, the orientation of the image component.

Specifically, for example, in a case where the user touches an end of the image component with one finger to select the image component, the user can change the orientation of the image component by sliding the touching one finger.

FIG. 10 is a diagram illustrating an exemplary concept of an operation of editing the orientation of an image component by a user sliding one finger in the first embodiment. Note that, in FIG. 10, a frame indicating that the image component is being selected is illustrated and denoted by 1001.

The operation reception unit 11 outputs attribute information of the image component edited by the sliding finger to the display control unit 12. The display control unit 12 changes the orientation of the image component displayed in the editing image display area 501 on the basis of the attribute information, and outputs the information of the second image after the orientation of the image component has been changed to the output control unit 15.

The output control unit 15 causes the projector 2 to display the first image on the basis of the information of the edited second image output from the display control unit 12. However, the output control unit 15 does not display the editing components. That is, the frame 1001 is not displayed.

As a result, the first image displayed on the object by the projector 2 is edited in real time. This also prevents the first image from becoming hard to see for viewers or the like since the editing components, which are not necessary for the viewers who view the first image and the user who is editing while viewing the first image, are not displayed by the projector 2.

(3) Editing Colors of an Image Component

A user can also edit colors in the second image displayed in the editing image display area 501 of the image editing screen. The user edits the second image and thereby reflects the edited content in the first image.

Colors to be edited include, for example, the color of each image component itself included in the second image or the background color of the second image. Note that it is assumed that a predetermined color is set as an initial value for each image component included in the second image. It is also assumed that the background of the image components or the background of the second image is set to be displayed in black on the image editing screen as an initial value (see FIG. 5). Note that in a case where the background color of the second image is set to black as the initial value, the initial value of the background color of the first figure displayed by the projector 2 is, for example, transparent.

The user first touches to select an image component. The specific operation is similar to the specific operation described in “(2) Editing the shape of an image component”, and thus its redundant description will be omitted.

The user selects an image component and edits the color of the image component.

Specifically, for example, the user touches a “colors” button (see FIG. 5) displayed in the editing function display area 503 with a finger to perform a color chart display operation of displaying a color chart as an editing component. The operation reception unit 11 receives the color chart display operation and outputs the color chart to the display control unit 12. The display control unit 12 displays the color chart on the image editing screen in a superimposed manner. The user changes the color of a selected image component by touching a desired color on the color chart displayed on the image editing screen in a superimposed manner. The operation reception unit 11 receives attribute information of the image component the color of which has been changed and outputs the attribute information to the display control unit 12. The display control unit 12 changes the color of the image component displayed in the editing image display area 501 on the basis of the attribute information, and outputs the information of the second image after the color of the image component has been changed to the output control unit 15.

The output control unit 15 causes the projector 2 to display the first image on the basis of the information of the edited second image output from the display control unit 12. However, the output control unit 15 does not display the editing components. That is, the color chart is not displayed.

As a result, the first image displayed on the object by the projector 2 is edited in real time. This also prevents the first image from becoming hard to see for viewers or the like since the editing components, which are not necessary for the viewers who view the first image and the user who is editing while viewing the first image, are not displayed by the projector 2.

(4) Editing the Brightness of an Image Component

A user can also edit the brightness of the second image displayed in the editing image display area 501 of the image editing screen. The user edits the second image and thereby reflects the edited content in the first image.

The user first touches to select an image component. The specific operation is similar to the specific operation described in “(2) Editing the shape of an image component”, and thus its redundant description will be omitted.

Note that the user can edit the brightness of the entire second image or the brightness of a part of the second image. In a case where the brightness of a part of the second image is edited, the user traces the part whose brightness is to be edited with a finger, for example. The operation reception unit 11 receives information of the part traced by the user's finger and outputs the information to the display control unit 12. The display control unit 12 displays, for example, a frame surrounding a portion traced by a user's finger. With this arrangement, the user can instantly grasp which part of the second image is to be edited by checking the image editing screen when partially editing the brightness of the second image.

The user selects an image component and edits the brightness of the image component.

Specifically, the user performs a brightness adjustment screen display operation of displaying a brightness adjustment screen as an editing component by, for example, touching a “brightness” button (not illustrated) displayed in the editing function display area 503 with a finger. The operation reception unit 11 receives the brightness adjustment screen display operation and outputs the operation to the display control unit 12. The display control unit 12 displays the brightness adjustment screen on the image editing screen in a superimposed manner. The user changes the brightness of a selected image component by touching a desired brightness on the brightness adjustment screen displayed on the image editing screen in a superimposed manner. The operation reception unit 11 receives attribute information of the image component the brightness of which has been changed and outputs the attribute information to the display control unit 12. The display control unit 12 modifies the brightness of the image component displayed in the editing image display area 501 on the basis of the attribute information, and outputs the information of the second image after the brightness of the image component has been changed to the output control unit 15.

The output control unit 15 causes the projector 2 to display the first image on the basis of the information of the edited second image output from the display control unit 12. However, the output control unit 15 does not display the editing components. That is, the brightness adjustment screen is not displayed.

As a result, the first image displayed on the object by the projector 2 is edited in real time. This also prevents the first image from becoming hard to see for viewers or the like since the editing components, which are not necessary for the viewers who view the first image and the user who is editing while viewing the first image, are not displayed by the projector 2.

(5) Editing an Animation Added to an Image Component

A user can also edit an animation attached to the second image displayed on the editing image display area 501 of the image editing screen. The user edits the second image and thereby reflects the edited content in the first image.

The user first touches to select an image component. The specific operation is similar to the specific operation described in “(2) Editing the shape of an image component”, and thus its redundant description will be omitted. However, in a case where an image component to which an animation is added is selected, the display control unit 12 displays editing components for editing the degree of the animation in addition to the operation described in “(2) Editing the shape of an image component”.

Here, a display image of image components for which the display control unit 12 displays editing components indicating the degree of an animation will be described with some examples. Note that, for the sake of simplicity of description, only the second image is illustrated in the following drawings illustrating the display image. Practically, the second image illustrated in the drawings is displayed in the editing image display area 501 of the image editing screen.

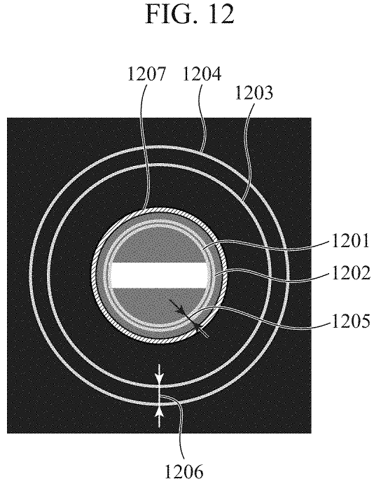

FIG. 11 is a diagram illustrating a concept of an exemplary screen on which the display control unit 12 displays editing components for editing the degree of an animation added to an image component in the first embodiment. Note that in FIG. 11, for convenience of explanation, an image component is one illustrating an arrow. Symbol 1103 in FIG. 11 denotes a frame indicating that the image component is being selected.

In FIG. 11, the animation is a sliding animation, and the display control unit 12 displays editing components for editing the degree of the sliding animation. Specifically, the display control unit 12 displays an editing component 1101 for editing the moving distance of the sliding animation and an editing component 1102 for editing the moving speed of the sliding animation.

The user can extend the moving distance of the sliding animation by broadening the width of the editing component 1101, and can shorten the moving distance of the sliding animation by narrowing the width of the editing component 1101. Meanwhile, the user can increase the moving speed of the sliding animation by elongating the editing component 1102, and can reduce the moving speed of the sliding animation by shortening the editing component 1102.

FIG. 12 is a diagram illustrating a concept of another exemplary screen on which the display control unit 12 displays editing components for editing the degree of an animation added to an image component in the first embodiment. Note that in FIG. 12, for convenience of explanation, an image component is a figure indicating an alarm signal. Symbol 1207 in FIG. 12 denotes a frame indicating that the image component is being selected.

In FIG. 12, the animation is a blinking animation, and the display control unit 12 displays editing components for editing the degree of the blinking animation. Specifically, the display control unit 12 displays a first circle 1201, a second circle 1202, a third circle 1203, and a fourth circle 1204, as editing components for editing the blinking degree of the blinking animation. The user can extend the turn-off time of the blinking animation by increasing the size of the first circle 1201, and shorten the turn-off time of the blinking animation by reducing the size of the first circle 1201. Moreover, the user can extend the fade-out time at the time when the blinking animation goes off by broadening the width 1205 of the first circle 1201 and the second circle 1202, and can shorten the fade-out time at the time when the blinking animation goes off by narrowing the width 1205. Meanwhile, the user can extend the turn-on time of the blinking animation by increasing the size of the fourth circle 1204, and can shorten the turn-on time of the blinking animation by reducing the size of the fourth circle 1204. Moreover, the user can extend the fade-out time at the time when the blinking animation is turned on by broadening the width 1206 of the third circle 1203 and the fourth circle 1204, and can shorten the fade-out time at the time when the blinking animation is turned on by narrowing the width 1206.

The user edits the animation added to the image component when the user selects an image component.

Specifically, for example, the user increases the moving speed of the sliding animation by touching both ends of the editing component 1102 for editing the moving speed of the sliding animation with two fingers and spreading the two fingers. In addition, for example, the user extends the turn-off time of the blinking animation by increasing the size of the first circle 1201 for editing the blinking animation. The operation reception unit 11 receives attribute information of the image component, to which the animation added has been changed, and outputs the attribute information to the display control unit 12. The display control unit 12 changes the animation added to the image component displayed in the editing image display area 501 on the basis of the attribute information, and outputs, to the output control unit 15, information of the second image after the animation added to the image component has been changed.

The output control unit 15 causes the projector 2 to display the first figure on the basis of the information of the edited second image output from the display control unit 12. However, the output control unit 15 does not display the editing components. That is, the editing components 1101 and 1102, the first circle 1201, the second circle 1202, the third circle 1203, and the fourth circle 1204 are not displayed.

As a result, the first image displayed on the object by the projector 2 is edited in real time. This also prevents the first image from becoming hard to see for viewers or the like since the editing components, which are not necessary for the viewers who view the first figure and the user who is editing while viewing the first image, are not displayed by the projector 2.

Note that, in the above description, the description has been given assuming that the animation originally added to the image component is edited. However, the limitation thereto is not intended, and the user can newly add an animation to an image component.

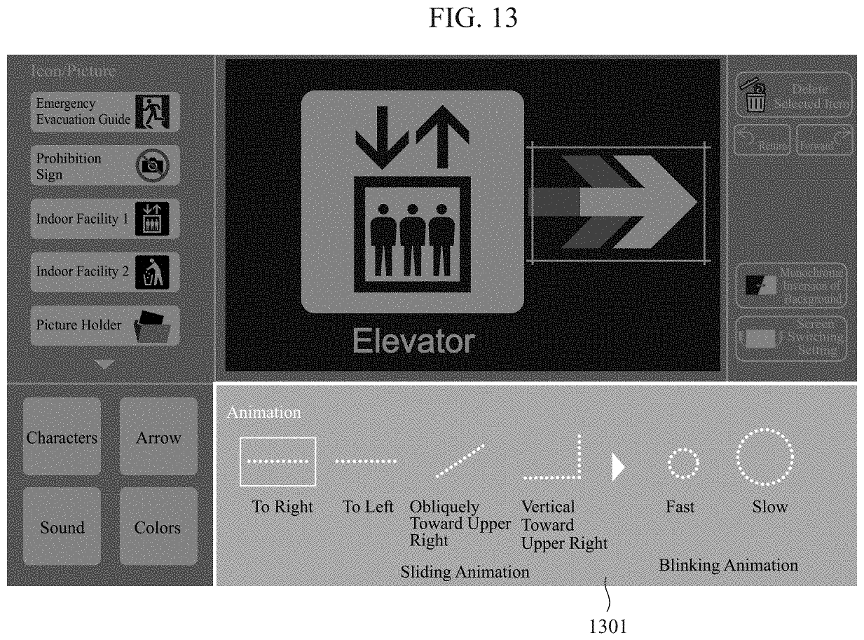

In this case, the user selects an image component, and then edits the animation by touching a desired animation from an animation setting screen (for example, see 1301 in FIG. 13) displayed in the editing function display area 503. The operation reception unit 11 receives attribute information of the image component after the animation has been added, and outputs the attribute information to the display control unit 12. The display control unit 12 adds the animation to the image component displayed in the editing image display area 501 on the basis of the attribute information, and outputs, to the output control unit 15, information of the second image after the animation has been added to the image component.

The output control unit 15 causes the projector 2 to display the first figure on the basis of the information of the edited second image output from the display control unit 12. However, the output control unit 15 does not display the editing components. That is, for example, the editing components 1101 and 1102 are not displayed.

(6) Deleting an Image Component

The user can also perform editing of deleting the second image displayed in the editing image display area 501 of the image editing screen. The user edits the second image and thereby reflects the edited content in the first image.

The user first touches to select an image component. The specific operation is similar to the specific operation described in “(2) Editing the shape of an image component”, and thus its redundant description will be omitted.

When the user selects an image component, the user performs editing of deleting the image component.

Specifically, for example, the user slides a finger touching the image component to move the image component from the current display position to a position outside the editing image display area 501. The operation reception unit 11 receives an editing operation of moving the image component from the current display position to a position outside the editing image display area 501, and outputs the editing operation to the display control unit 12. The display control unit 12 deletes the image component from the image editing screen, and outputs information of the second image after the deletion of the image component to the output control unit 15.

The output control unit 15 causes the projector 2 to display the first image on the basis of the information of the edited second image output from the display control unit 12. However, the output control unit 15 does not display the editing components.

As a result, the first image displayed on the object by the projector 2 is edited in real time. This also prevents the first image from becoming hard to see for viewers or the like since the editing components, which are not necessary for the viewers who view the first image and the user who is editing while viewing the first image, are not displayed by the projector 2.

Note that the display control unit 12 can cause the list display screen (see FIG. 7) of the classification to which the image component belongs to be superimposed and displayed on the image editing screen when deleting the image component from the image editing screen. For example in a case where the user accidentally deletes an image component from the image editing screen, the user touches the image component again from the image editing screen to select it and slides the image component to the editing image display area 501.

The operation reception unit 11 receives an editing operation of sliding the image component to the editing image display area 501, and the display control unit 12 displays the image component again in the editing image display area 501, and then, outputs, to the output control unit 15, information of the second figure after the image component has been edited.

The output control unit 15 causes the projector 2 to display the first image on the basis of the information of the edited second image output from the display control unit 12. In this manner, even when the user accidentally deletes an image component from the image editing screen, the image component can be quickly displayed again, and the first image based on the information of the edited second image can be displayed from the projector 2.

As described above with reference to the flowchart of FIG. 6 and other diagrams, the editing device 1 edits the first image displayed by the projector 2 in real time on the basis of the user's operation. At this time, the editing device 1 causes the display unit 101 to superimpose on the second image and display editing components for editing the second image. Meanwhile, the editing device 1 does not display the editing components when causing the projector 2 to display the first image on the basis of the edited second image. The user can edit the first image in real time while the first image displayed on the floor is kept clearly visible.

Note that, although not described in the above description of operation described with reference to FIG. 6 and other diagrams, in the editing device 1, the operation restriction unit 14 restricts the operation by the operation reception unit 11 as appropriate depending on an operation received by the operation reception unit 11.

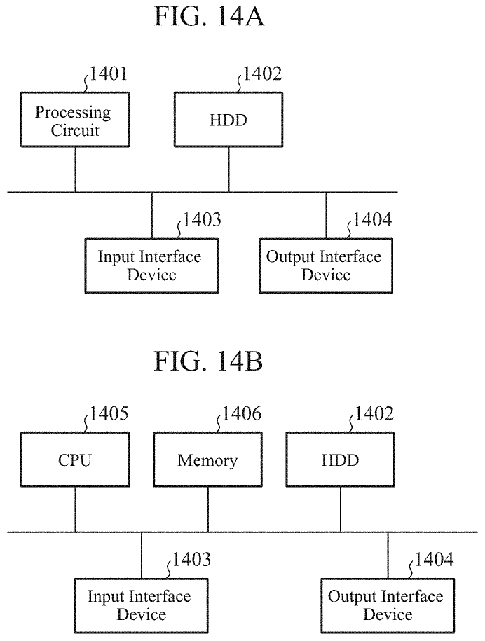

FIGS. 14A and 14B are diagrams illustrating exemplary hardware configurations of the editing device 1 according to the first embodiment of the present invention.

In the first embodiment of the invention, the functions of the operation reception unit 11, the display control unit 12, the image registration controlling unit 13, the operation restriction unit 14, and the output control unit 15 are implemented by a processing circuit 1401. That is, the editing device 1 includes the processing circuit 1401 for controlling the editing of the first figure which is displayed by the projector 2.

The processing circuit 1401 may be dedicated hardware as illustrated in FIG. 14A or may be a central processing unit (CPU) 1405 for executing a program stored in a memory 1406 as illustrated in FIG. 14B.

In a case where the processing circuit 1401 is dedicated hardware, the processing circuit 1401 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit 1401 is the CPU 1405, the functions of the operation reception unit 11, the display control unit 12, the image registration controlling unit 13, the operation restriction unit 14, and the output control unit 15 are implemented by software, firmware, or a combination of software and firmware. That is, the operation reception unit 11, the display control unit 12, the image registration controlling unit 13, the operation restriction unit 14, and the output control unit 15 are implemented by the CPU 1405 or a processing circuit such as a system large scale integration (LSI) that executes a program stored in, for example, a hard disk drive (HDD) 1402 or the memory 1406. It is also understood that programs stored in the HDD 1402, the memory 1406, and the like cause a computer to execute the procedures and methods of the operation reception unit 11, the display control unit 12, the image registration controlling unit 13, the operation restriction unit 14, and the output control unit 15. Here, the memory 1406 may be, for example, a nonvolatile or volatile semiconductor memory such as a random access memory (RAM), a read only memory (ROM), a flash memory, an erasable programmable read only memory (EPROM), or an electrically erasable programmable read only memory (EEPROM); a magnetic disc, a flexible disc, an optical disc, a compact disc, a mini disc, or a digital versatile disc (DVD).

Note that some of the functions of the operation reception unit 11, the display control unit 12, the image registration controlling unit 13, the operation restriction unit 14, and the output control unit 15 may be implemented by dedicated hardware and another part thereof may be implemented by software or firmware. For example, the function of the operation reception unit 11 may be implemented by the processing circuit 1401 as dedicated hardware, and the functions of the display control unit 12, the image registration controlling unit 13, the operation restriction unit 14, and the output control unit 15 may be implemented by the processing circuit reading and executing a program stored in the memory 1406.

As the image database 16, for example, the HDD 1402 is used. Note that this is merely one example, and the image database 16 may be implemented by, for example, a DVD or the memory 1406.

The editing device 1 also includes an input interface device 1403 and an output interface device 1404 that communicate with an external device such as the projector 2.

As described above, according to the first embodiment, the editing device 1 is for editing a first image in a state where the output device (projector 2) is displaying the first image, and includes: the display control unit 12 for displaying a second image corresponding to the first image and an editing component for editing the second image on the image editing screen; and the output control unit 15 for generating an output image for the output device to display the first image on the basis of the second image edited using the editing component displayed by the display control unit 12, and outputting the output image to the output device.

Therefore, it is possible to edit the image in real time while the image is being displayed by the output device.

The editing device 1 displays both the second image and editing components on the image editing screen. On the other hand, the editing device 1 does not use the editing components displayed on the image editing screen when the output control unit 15 generates an output image. Therefore, the editing components displayed on the image editing screen are not displayed when the output control unit 15 causes the projector 2 to display the first image. As a result, this also prevents the first image from becoming hard to see for viewers or the like since the editing components, which are not necessary for the viewers who view the first image and the user who is editing while viewing the first image, are not displayed by the projector 2.

### Second Embodiment

In the first embodiment, the second image has a predetermined color when the editing device 1 displays the second image in the editing image display area 501 of the image editing screen. In addition, the background color of the second image has basically an initial value such as black.

In a second embodiment, description is given on an embodiment in which an editing device 1 displays a second image in an editing image display area 501 in such a manner that information about the real space in which a first image is displayed is considered.

Although the illustration of a configuration example of an editing system 1000a including an editing device 1a according to the second embodiment is omitted, the editing system 1000a is different from the editing system 1000 described in the first embodiment with reference to FIG. 1 only in that a real space information acquiring device (not illustrated) is included.

The real space information acquiring device is, for example, a camera or a laser lidar. The real space information acquiring device acquires information about the real space in which the projector 2 is displaying the first image (hereinafter referred to as “spatial information”). Specifically, in a case where the real space information acquiring device is a camera, the camera captures an image of the projection surface on which the first image is displayed by the projector 2 and acquires the captured image as the spatial information. Alternatively, in a case where the real space information acquiring device is a laser lidar, the laser lidar acquires information regarding the presence or absence of an obstacle on the projection surface on which the first image is displayed by the projector 2 as the spatial information.

The real space information acquiring device may be included, for example, in the projector 2, or may be installed on the ceiling or the like that is vertical to the projection surface on which the projector 2 is displaying the first image. In the second embodiment, as an example, the real space information acquiring device is installed on the ceiling vertical to the projection surface on which the projector 2 is displaying the first image.

The editing device 1a acquires the spatial information from the real space information acquiring device, creates editing guide information on the basis of the spatial information, and displays the editing guide information in the editing image display area 501 when the second image is displayed. The editing guide information is information related to a structure present in the real space, such as the center of the floor, the center line of a passage, or an obstacle, and is information that is a target when the user edits the second image. With the editing guide information being displayed, the user can edit the second image on the image editing screen with a feeling as if in the real space in which the first image is displayed.

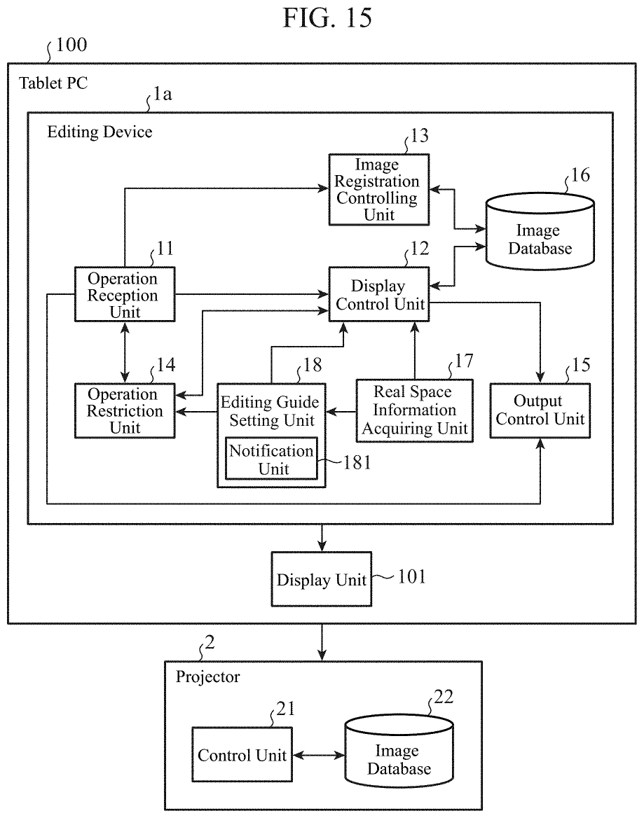

FIG. 15 is a diagram illustrating a configuration example of the editing device 1a according to the second embodiment.

In FIG. 15, components similar to those of the editing device 1 described with reference to FIG. 4 in the first embodiment are denoted by the same symbol, and their redundant descriptions will be omitted.

The editing device 1a illustrated in FIG. 15 is different from the editing device 1 described with reference to FIG. 4 in that the editing device 1a includes a real space information acquiring unit 17 and an editing guide setting unit 18. The editing guide setting unit 18 includes a notification unit 181.

The real space information acquiring unit 17 acquires spatial information from a real space information acquiring device.

The real space information acquiring unit 17 outputs the acquired spatial information to an editing guide setting unit 18. Moreover, in a case where an image of the projection surface captured by a camera is acquired as the spatial information, the real space information acquiring unit 17 outputs the image to a display control unit 12.

The editing guide setting unit 18 sets editing guide information on the basis of the spatial information output from the real space information acquiring unit 17. The editing guide information includes, for example, information about the material of the projection surface of the object on which the projector 2 displays the first image, the color of the projection surface, the inclination of the projection surface, an obstacle present on the projection surface, or a wall. The editing guide setting unit 18 detects the material of the projection surface of the object on which the projector 2 displays the first image, the color of the projection surface, the inclination of the projection surface, an obstacle present on the projection surface, or a wall on the basis of the spatial information and sets editing guide information. The editing guide setting unit 18 is only required to detect the material of the projection surface, etc. that are described above by using existing image processing technology or the like.

The editing guide setting unit 18 outputs the set editing guide information to the display control unit 12 and an operation restriction unit 14.

The display control unit 12 causes information based on the editing guide information output from the editing guide setting unit 18 to be displayed together with the second image when displaying a second image in the editing image display area 501 of the image editing screen. Its details will be described later.

Furthermore, the operation restriction unit 14 causes an operation reception unit 11 to restrict the operation of receiving an editing operation of the second image on the basis of the editing guide information output from the editing guide setting unit 18. Its details will be described later.

The notification unit 181 of the editing guide setting unit 18 outputs feedback, on the operation for which the operation reception unit 11 has received the editing operation, on the basis of the editing guide information. Its details will be described later.

The hardware configuration of the editing device 1a according to the second embodiment is similar to the hardware configuration of the editing device 1 described in the first embodiment with reference to FIGS. 14A and 14B, and thus its redundant description will be omitted. The real space information acquiring unit 17 and the editing guide setting unit 18 have a hardware configuration similar to that of the operation reception unit 11, the display control unit 12, the image registration controlling unit 13, the operation restriction unit 14, and the output control unit 15.

The operation of the editing device 1a of the second embodiment will be described.

The operation of the editing device 1a according to the second embodiment is basically similar to the operation of the editing device 1 described in the first embodiment with reference to the flowchart of FIG. 6.

In the editing device 1a according to the second embodiment, that the information based on the editing guide information is displayed in the editing image display area 501 when the image editing screen is displayed is different from the editing device 1 of the first embodiment.

Hereinafter, regarding the operation of the editing device 1a, only the operation different from that of the editing device 1 of the first embodiment will be described, and its redundant description of the operation similar to that of the editing device 1 of the first embodiment will be omitted.

When the operation reception unit 11 receives a call operation for the image editing screen (see step ST601 in FIG. 6), the display control unit 12 causes the display unit 101 to display the image editing screen (see step ST602 and step ST603 in FIG. 6). The display control unit 12 displays information based on the editing guide information output from the editing guide setting unit 18 in the editing image display area 501 of the image editing screen when executing display of the image editing screen.

Hereinafter, an operation by the display control unit 12 to display information based on the editing guide information in the editing image display area 501 will be described with a specific example.

The display control unit 12 displays a second image in the editing image display area 501, and also displays, for example, information indicating that there is an obstacle on the basis of the editing guide information.

When the editing guide setting unit 18 detects an obstacle on the basis of the spatial information output from the real space information acquiring unit 17, the editing guide setting unit 18 outputs information which indicates that there is an obstacle to the display control unit 12 as editing guide information. The information indicating that there is an obstacle includes, for example, information indicating the shape of the obstacle or the distance from the displayed first image to the obstacle.

The display control unit 12 displays information indicating that there is an obstacle in the editing image display area 501 on the basis of the editing guide information output from the editing guide setting unit 18.

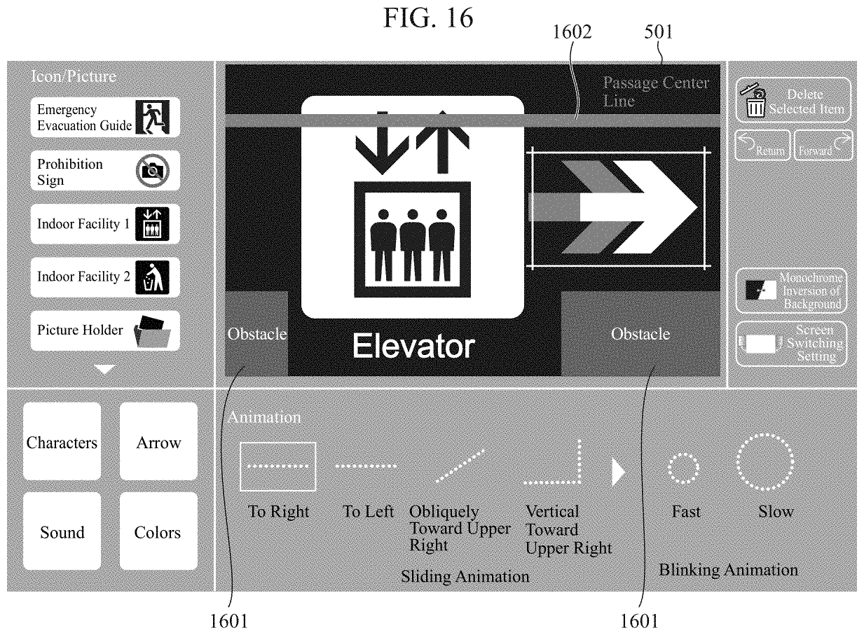

FIG. 16 is a diagram illustrating an exemplary concept of the editing image display area 501 in which the display control unit 12 displays information based on editing guide information in the second embodiment.

As illustrated by 1601 in FIG. 16, the display control unit 12 displays information of an obstacle in the editing image display area 501.

In a case where the user moves an image component included in the second image on the editing image display area 501, the operation restriction unit 14 restricts the operation reception unit 11 so as not to receive an editing operation of moving the image component in a direction in which the image component and the obstacle overlap more with each other when the image component is moved to a position where the image component and an obstacle overlap on the basis of the editing guide information. The user becomes unable to move the image component in the editing image display area 501 in such a direction in which the image component and the obstacle overlap more with each other.

At this point, the notification unit 181 of the editing guide setting unit 18 may notify that the image component cannot be moved in a direction in which the image component and the obstacle overlap with each other since the image component and the obstacle overlap, by giving feedback to the user such as by vibrating the tablet PC 100. The user recognizes that the image component and the obstacle overlap in the editing image display area 501 when the tablet PC 100 vibrates. That is, the user recognizes that the first image overlaps the obstacle on the floor.

Furthermore, for example, in a case where the projection surface is a limited space such as a passage, the display control unit 12 can display the second image in the editing image display area 501 and display information indicating the center of the space on the basis of the editing guide information. Specifically, for example, if the projection surface is a passage, the display control unit 12 can display information indicating the center line of the passage.

The editing guide setting unit 18 detects the center line of the passage when the passage is detected on the basis of the spatial information output from the real space information acquiring unit 17. The information of the center line of the passage is stored in advance in a storage device (not illustrated) that can be referred to by the editing guide setting unit 18. The editing guide setting unit 18 detects the center line of the passage on the basis of the information of the center line of the passage stored in advance and the spatial information output from the real space information acquiring unit 17, and outputs the information of the center line to the display control unit 12 as editing guide information. The editing guide information includes information of the positional relationship between the center line and the first image.

The display control unit 12 displays the information indicating the center line of the passage on the basis of the editing guide information output from the editing guide setting unit 18 (1602 in FIG. 16).

The user uses the center line of the passage displayed in the editing image display area 501 as a reference, and edits the position of the image component included in the second image so that the image component is arranged at a position where a viewer can clearly see. Specifically, the user touches the image component with a finger in the editing image display area 501 and slides the image component to an appropriate position while using the display indicating the center line of the passage as a guide.

Since the center line of the passage is displayed, it is clear for the user to see where to position the image component in the editing image display area 501. The display control unit 12 outputs the information of the second image after the image component has been moved to the output control unit 15, and the output control unit 15 causes the projector 2 to display the first image on the basis of the second image. As a result, the user can easily display the first image at a position where the viewer can clearly see, using the center line of the passage as a reference.

In a case where the user moves an image component in the editing image display area 501, the notification unit 181 of the editing guide setting unit 18 can notify that the image component is displayed at an appropriate position when the image component is moved to an appropriate position with respect to the center line of the passage on the basis of the editing guide information. Specifically, for example, the notification unit 181 of the editing guide setting unit 18 notifies that the image component has been moved to an appropriate position with respect to the center line by giving feedback to the user, such as vibrating the tablet PC 100, or slightly moving the image component by an action as if the image component is pulled toward the appropriate position. The user recognizes that the image component has been moved to the appropriate position in the editing image display area 501 by vibrating the tablet PC 100 or other actions. That is, the user recognizes that the first image is displayed at an appropriate position on the floor.

Furthermore, at this time, the operation restriction unit 14 may restrict the operation reception unit 11 so as not to receive an editing operation of moving the image component from the current appropriate position. Note that an appropriate position with respect to the center line is determined in advance, and the information of the appropriate position is stored in a storage device (not illustrated) that the editing guide setting unit 18 can refer to.

Furthermore, for example, the display control unit 12 can display the second image in the editing image display area 501 and also display information indicating the material or the color of the projection surface on the basis of the editing guide information.

The editing guide setting unit 18 detects the material or the color of the projection surface on the basis of the spatial information output from the real space information acquiring unit 17, and outputs, to the display control unit 12, the information regarding the material or the color as the editing guide information. The material of the projection surface may be, for example, wood, a carpet, or tiles.

The display control unit 12 displays information indicating the material or the color of the projection surface on the basis of the editing guide information output from the editing guide setting unit 18. Specifically, for example, in a case where editing guide information indicating that the material of the projection surface is a carpet is output, the display control unit 12 displays a pattern simulating the unevenness of the carpet surface due to the length of the carpet pile. The pattern simulating the unevenness of the carpet surface is set in advance. Here, as an example, it is assumed that oblique lines are set in advance as a pattern simulating the unevenness of the carpet surface.

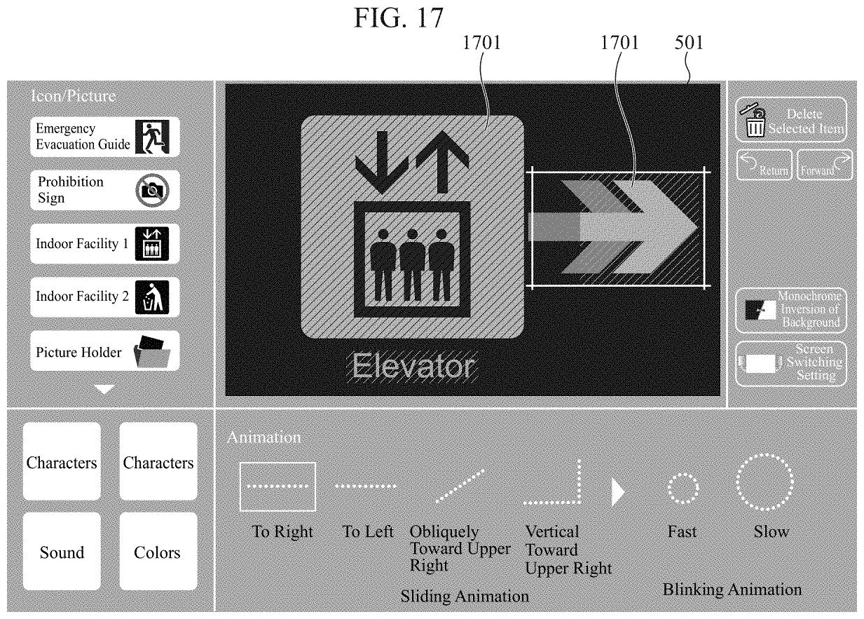

FIG. 17 is a diagram illustrating another exemplary concept of the editing image display area 501 in which the display control unit 12 displays information based on editing guide information in the second embodiment.

As illustrated by 1701 in FIG. 17, the display control unit 12 displays the pattern simulating the unevenness of the carpet surface on the second image in a superimposed manner.

Note that the above is merely an example, and the editing guide setting unit 18 can set information indicating the material in editing guide information on the basis of the material of a projection surface, and the display control unit 12 can display a pattern simulating the material of the projection surface on the basis of the editing guide information.

In a case where the editing guide setting unit 18 outputs editing guide information in which the color of a projection surface is set, the display control unit 12 can change the background of the second image displayed in the editing image display area 501 on the basis of the editing guide information.

Furthermore, in a case where the user edits the color or the brightness of an image component included in the second image on the editing image display area 501, the operation restriction unit 14 can cause the operation reception unit 11 to restrict the operation of receiving an editing operation of editing the color or the brightness of the image component on the basis of the editing guide information. For example, in a case where the editing guide information indicates that the projection surface is a black carpet, the operation restriction unit 14 restricts the operation reception unit 11 so as not to receive an editing operation of setting a red color to an image component included in the second image. Or, in a case where the editing guide information indicates that the projection surface is a black carpet, the operation restriction unit 14 may restrict the operation reception unit 11 so as to receive only editing operations of designating white, yellow, or a recommended color such as yellowish green as an editing operation of editing the color of an image component included in the second image. Furthermore, the operation restriction unit 14 may cause the display control unit 12 to display a color chart including only recommended colors when the operation reception unit 11 receives a display operation of the color chart.

Note that what type of color is recommended as an edited color is predetermined depending on what type of material or color of the projection surface is used.

Furthermore, for example, the display control unit 12 can display the second image in the editing image display area 501 and also display information indicating the inclination of the projection surface on the basis of the editing guide information.

The editing guide setting unit 18 detects the inclination of the projection surface on the basis of the spatial information output from the real space information acquiring unit 17, and outputs, to the display control unit 12, the information regarding the inclination as the editing guide information.

The display control unit 12 displays information indicating the inclination of the projection surface on the basis of the editing guide information output from the editing guide setting unit 18. Specifically, for example, in a case where information indicating the inclination of the projection surface is output, the display control unit 12 displays the second image in a skewed state depending on the inclination of the projection surface.

In a case where the user moves an image component included in the second image in the editing image display area 501, the operation restriction unit 14 can cause the operation reception unit 11 not to receive an editing operation of moving the image component further in a direction in which the image component overlaps with an area where the inclination is detected on the basis of the editing guide information when the image component reaches the area where the inclination is detected.

In the above description, the example has been described in which the display control unit 12 controls the display of the editing image display area 501 on the basis of the editing guide information output from the editing guide setting unit 18.

However, without being limited thereto, in a case where an image captured by a camera is acquired from the real space information acquiring unit 17 as editing guide information, the display control unit 12 can set and display the image as the background in the editing image display area 501. In a case where an image captured by the camera as the background, the user can see the second image displayed in the editing image display area 501 in a state close to the state in which the first image is actually displayed.

The editing guide information and the image set in the editing image display area 501 are editing components. Therefore, when the output control unit 15 causes the projector 2 to display the first image on the basis of the second image, the editing guide information or the image set as the background of the editing image display area 501 is not displayed, like other editing components.

Note that, in the second embodiment described above, as an example, the real space information acquiring device is installed on the ceiling vertical to the projection surface on which the projector 2 is projecting a first figure. This is merely an example, and the real space information acquiring device is only required to be installed at a position where the spatial information can be acquired which is related to the real space where the projector 2 is displaying the first image. Note that, in a case where the real space information acquiring device is not installed at a position where the information of the projection surface is acquired from a vertical direction with respect to the projection surface, the real space information acquiring unit 17 corrects the spatial information so that the spatial information becomes one that is viewed from the vertical direction with respect to the projection surface when acquiring the spatial information. The real space information acquiring unit 17 is only required to correct the spatial information using existing technology.

As described above, according to the second embodiment, the editing device 1a includes, in addition to the configuration of the editing device 1 according to the first embodiment, the real space information acquiring unit 17 for acquiring spatial information related to a real space in which the first image is displayed, and the editing guide setting unit 18 for setting editing guide information related to a structure present in the real space on a basis of the spatial information acquired by the real space information acquiring unit 17, in which the display control unit 12 is configured to display an image based on the editing guide information together with the second image. This allows the user to more easily edit the displayed first image.

### Third Embodiment

In the first embodiment, the viewpoint of a viewer is not considered when the editing device 1 generates a projection image as an output image and causes the projector 2 as an output device to display a first image.

In a third embodiment, an embodiment will be described in which an output image is generated so that a first image is displayed in a preset size and orientation when viewed from a viewer considering the viewpoint of the viewer who visually recognizes the first image.

The configuration of the editing system 1000 including an editing device 1b according to the third embodiment is similar to the configuration of the editing system 1000 described with reference to FIG. 1 in the first embodiment, and thus its redundant description will be omitted.

The hardware configuration of the editing device 1b according to the third embodiment is similar to the hardware configuration described with reference to FIGS. 14A and 14B, and thus its redundant description will be omitted.

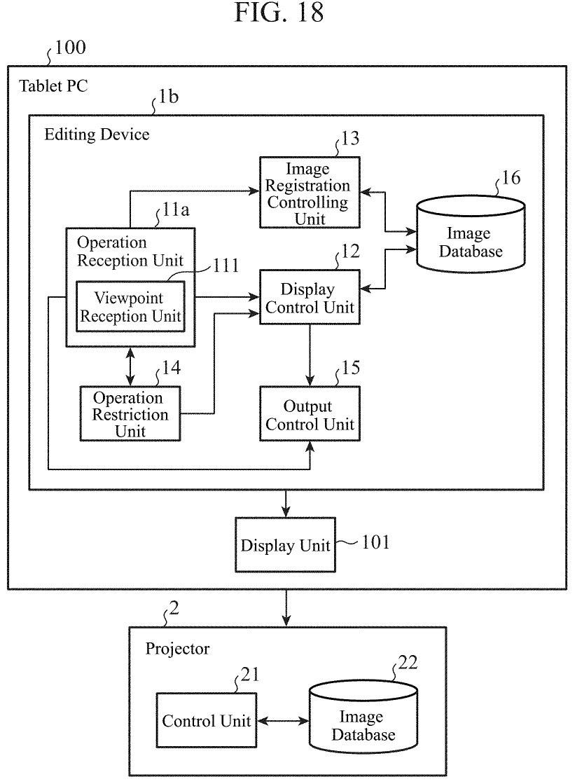

FIG. 18 is a diagram illustrating a configuration example of the editing device 1b of the third embodiment.

In FIG. 18, components similar to those of the editing device 1 described with reference to FIG. 4 in the first embodiment are denoted by the same symbol, and its redundant description will be omitted.

The editing device 1b illustrated in FIG. 18 is different from the editing device 1 of the first embodiment in that an operation reception unit 11a includes a viewpoint reception unit 111.

The viewpoint reception unit 111 receives information regarding the viewpoint of a viewer (hereinafter referred to as “viewpoint information”). The viewpoint information includes, for example, the height of the viewpoint of the viewer, the distance between the projector 2 and the viewer, or information regarding the positional relationship between the projector 2 and the viewer, and enables determination of the viewpoint of the viewer.

A user touches a display unit 101 to input viewpoint information. Specifically, for example, the user touches the display unit 101 to perform a screen call operation of calling a viewpoint information input screen. The operation reception unit 11 receives the screen call operation, and the display control unit 12 causes the display unit 101 to display the viewpoint information input screen. The user touches the display unit 101 to input viewpoint information from the viewpoint information input screen. Specifically, for example, the user performs an input operation of inputting, as viewpoint information, information indicating that the position of the viewer is “30 meters away in the direction of 90 degrees to the left with respect to the front direction of the projector” and information indicating that the height of the viewer is “160 centimeters”. The viewpoint reception unit 111 receives the input operation of the viewpoint information performed by the user.

The viewpoint reception unit 111 outputs the viewpoint information to the output control unit 15 on the basis of the received input operation.

In the third embodiment, the output control unit 15 generates a projection image as an output image so that the first image is displayed with a preset size and orientation when viewed from the viewer on the basis of the viewpoint information when the projector 2 is caused to display the first image on the basis of the information of the second image output from the display control unit 12.

Specifically, the output control unit 15 generates a projection image for displaying the first image the shape of which is modified or rotated with respect to a projection image for displaying the first image of a case where there is no consideration to the viewpoint information, on the basis of the positional relationship between the projector 2 and the projection surface, the information of the second image, and the viewpoint information.

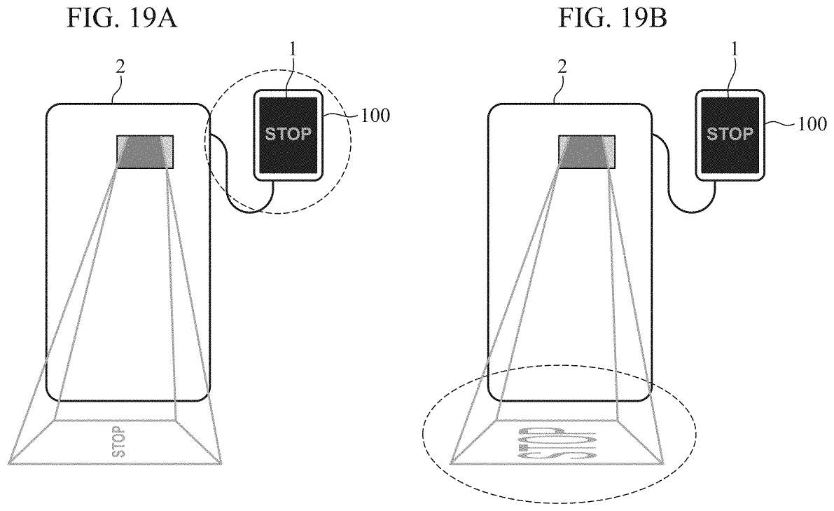

FIGS. 19A-19B are diagrams illustrating an example of an image in which, in the third embodiment, the output control unit 15 displays a first image obtained by modifying or rotating the first image so that the first image is displayed in a preset size and orientation when viewed from a viewer.

In FIG. 19, the first image displayed by the output control unit 15 is a character string of “Stop”.

As illustrated in FIG. 19A, let us assume that, a user inputs, as viewpoint information, information of a viewpoint of a person that being 160 centimeters tall at a position 30 meters away in a direction 90 degrees to the left with respect to the front direction of the projector while “Stop” is being displayed on the floor. In this case, as illustrated in FIG. 19B, the output control unit 15 stretches “Stop” in the vertical direction to generate such a projection image that the “Stop” is projected in a preset size and orientation when seen by the viewer.

In the operation of the editing device 1b of the third embodiment, in addition to the operation similar to that of the editing device 1 according to the first embodiment, the viewpoint reception unit 111 receives viewpoint information, and the output control unit 15 generates such an output image that displays the first image in a preset size and orientation when viewed from a viewer on the basis of viewpoint information as described above.

The operation similar to that of the editing device 1 of the first embodiment has already been described, and thus its redundant description will be omitted.

Note that although the output control unit 15 displays the first image whose size and orientation are modified on the basis of the information of the second image and the viewpoint information in the above description, this is merely an example. The output control unit 15 can also change one or more of the orientations, the color, and other attributes of the first image on the basis of the information of the second image and the viewpoint information.

As described above, the editing device 1b of the third embodiment includes, in addition to the configuration of the editing device 1 of the first embodiment, the viewpoint reception unit 111 for receiving viewpoint information related to the viewpoint of a viewer who visually recognizes the first image, in which the output control unit 15 generates an output image on the basis of the second image and the viewpoint information received by the viewpoint reception unit 111.

As a result, the editing device 1b can cause an output device to display the first image that is clearly visible to the viewer depending on the viewpoint of the viewer.

### Fourth Embodiment

In the first embodiment, the surrounding environment of the projector 2 is not considered when the editing device 1 generates a projection image as an output image and causes the projector 2 as an output device to display a first image.

In a fourth embodiment, an embodiment will be described in which an output image is generated in consideration of the surrounding environment of an output device when a first image is displayed.

The configuration of an editing system 1000 including an editing device 1c according to the fourth embodiment is similar to the configuration of the editing system 1000 described with reference to FIG. 1 in the first embodiment, and thus its redundant description will be omitted.

The hardware configuration of the editing device 1c according to the fourth embodiment is similar to the hardware configuration described with reference to FIGS. 14A and 14B, and thus its redundant description will be omitted.

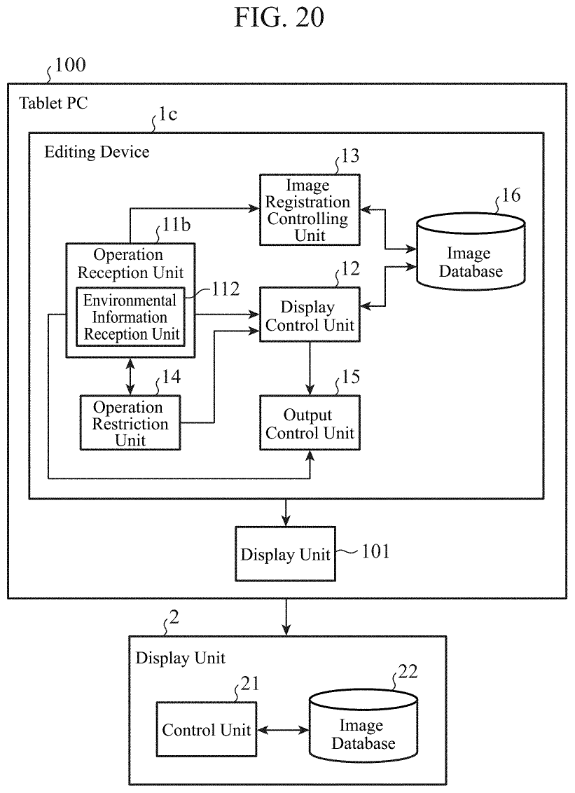

FIG. 20 is a diagram illustrating a configuration example of the editing device 1c of the fourth embodiment.

In FIG. 20, components similar to those of the editing device 1 described with reference to FIG. 4 in the first embodiment are denoted by the same symbol, and its redundant description will be omitted.

The editing device 1c illustrated in FIG. 20 is different from the editing device 1 according to the first embodiment in that an operation reception unit 11b includes an environmental information reception unit 112.

The environmental information reception unit 112 receives information regarding the surrounding environment of the projector 2 (hereinafter referred to as “environmental information”). The environmental information includes, for example, information regarding the intensity of the natural light around the projector 2, the direction from which the natural light enters as viewed from the projector 2, the material of the projection surface, the color of the projection surface, or the inclination of the projection surface.

The user touches a display unit 101 to input the environmental information. Specifically, for example, the user touches the display unit 101 to perform a screen call operation of calling an environmental information input screen. The operation reception unit 11 receives the screen call operation, and a display control unit 12 causes the display unit 101 to display the environmental information input screen. The user touches the display unit 101 to perform an input operation of the environmental information from the environmental information input screen. The environmental information reception unit 112 receives the input operation of the environmental information performed by the user.

The environmental information reception unit 112 outputs the environmental information to an output control unit 15 on the basis of the received input operation.

In the fourth embodiment, the output control unit 15 generates an output image so that the first image is displayed with the same the color and shape as those of the second image on the basis of the information of the second image output from the display control unit 12 and the environmental information.

For example, in a case where the environmental information reception unit 112 outputs environment information indicating that the natural light is strong, the output control unit 15 generates an output image that enables display of the first image with low brightness.

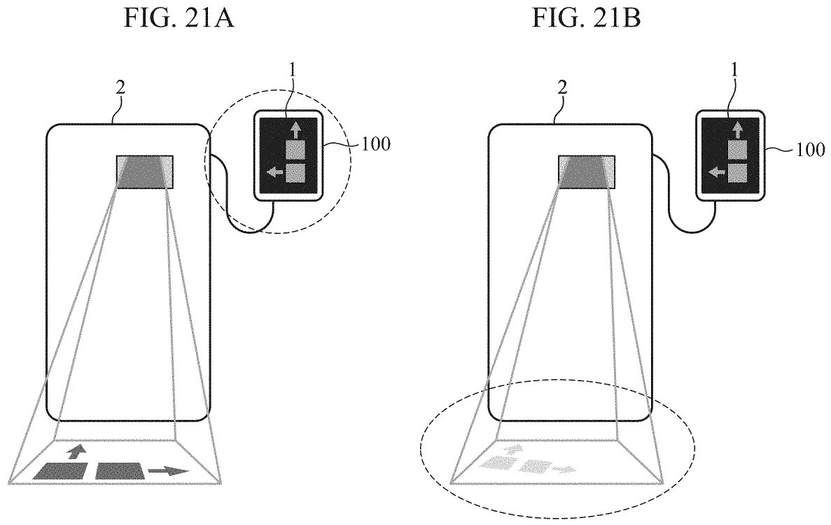

FIGS. 21A-21B are diagrams illustrating an example of an image in which, in the fourth embodiment, the output control unit 15 displays a first image obtained by changing the brightness or the color of the first image, compared to a case where there is no consideration to the environmental information, so that the first image having the same color and shape as those of the second image is displayed.

In FIGS. 21A and 21B, it is assumed that the first image caused to be projected by the output control unit 15 includes two sets of figures each of which includes a combination of a square figure and an arrow figure.

It is assumed that the user inputs environmental information indicating that the projection surface is inclined and that the illumination is dark in a state where the first image is displayed as illustrated in FIG. 21A. In this case, as illustrated in FIG. 21B, the output control unit 15 generates an output image that corrects the orientation of the first image in accordance with the inclination and corrects the brightness of the first image to a large value.

The operation of the editing device 1c according to the fourth embodiment, in addition to the same operation as the editing device 1 according to the first embodiment, as described above, the environmental information reception unit 112 receives environmental information, and the output control unit 15 generates, on the basis of the environmental information, an output image and causes the projector 2 to display the first image so that the first image is displayed with the same color and shape as those of the second image displayed in the editing image display area 501 of the image editing screen.

The operation similar to that of the editing device 1 of the first embodiment has already been described, and thus its redundant description will be omitted.

Note that although the output control unit 15 displays the first image whose orientation and brightness are modified on the basis of the information of the second image and the environmental information in the above description, this is merely an example. The output control unit 15 can change any one or more of the colors, the size, or other attributes of the first image on the basis of the information of the second image and the environmental information.

As described above, the editing device 1c of the fourth embodiment includes, in addition to the configuration of the editing device 1 of the first embodiment, the environmental information reception unit 112 for receiving environmental information related to the surrounding environment of the output device (projector 2), in which the output control unit 15 generates an output image on the basis of the second image and the environmental information received by the environmental information reception unit 112. As a result, the editing device 1c can cause the output device to display the first image that is clearly visible to the viewer regardless of the environment in which the viewer visually recognizes the first image.

It is assumed in the first to fourth embodiments described above that the editing devices 1, 1a, 1b, and 1c are mounted on the tablet PC 100; however, this is merely an example. The editing devices 1, 1a, 1b, and 1c may be mounted on, for example, a desktop PC that can communicate with the projector 2 as an output device or a smartphone that is owned by an individual. In addition, the editing devices 1, 1a, 1b, and 1c may be mounted on the projector 2 itself in a case where the projector 2 includes a display unit including a touch panel or the like.

Furthermore, it is assumed in the above-described first to fourth embodiments that the output device that displays a first image is the projector 2; however, this is merely an example. An output device that displays the first image may be, for example, a spontaneous light-emitting device such as a liquid crystal display, and the first image may be displayed on the spontaneous light-emitting device itself. However, the operation of displaying a pattern simulating the material, color, or other attributes of the projection surface, and the operation of displaying information indicating the inclination of the projection surface in the editing image display area 501 by the editing devices 1, 1a, 1b, and 1c, as described in the second embodiment, are not applied to the editing device of a case where a spontaneous light-emitting device is used as the output device.

Furthermore, although the projector-side image database 22 is included in the projector 2 in the above-described first to fourth embodiments, without limitation thereto, the projector-side image database 22 may be provided outside the projector 2 at a location where the projector 2 can refer to.

Meanwhile, the projector 2 includes the projector control unit 21 and the projector-side image database 22 in the above-described first to fourth embodiments; however, this is merely an example. For example, there are cases where a PC such as a tablet PC other than the tablet PC 100 mounted with the editing device 1, 1a, 1b, or 1c (hereinafter referred to as “projector control PC”) may be communicably connected to one or more projectors 2 by wire or wirelessly for controlling each of the projectors 2. In this case, each projector control PC may include a projector control unit 21 and a projector-side image database 22.

Furthermore, in the above-described first to fourth embodiments, the projector 2 includes the projector-side image database 22; however, as illustrated in FIG. 1A, the projector-side image database 22 does not need to be included in a case where one tablet PC 100 is connected with only one projector 2.

Note that the present invention may include a flexible combination of the embodiments, a modification of any component of the embodiments, or an omission of any component in the embodiments within the scope of the present invention.

### INDUSTRIAL APPLICABILITY

An editing device according to the present invention enables editing of an image in real time while an output device is displaying the image, and thus is applicable to an editing device for editing an image displayed by an output device.

### REFERENCE SIGNS LIST

1, 1a, 1b, 1c: editing device, 2: projector, 11, 11a, 11b: operation reception unit, 12: display control unit, 13: image registration controlling unit, 14: operation restriction unit, 15: output control unit, 16: image database, 17: real space information acquiring unit, 18: editing guide setting unit, 21: control unit (projector control unit), 22: image database (projector-side image database), 100: tablet pc, 101: display unit, 111: viewpoint reception unit, 112: environmental information reception unit, 181: notification unit, 1000, 1000a: editing system, 1401: processing circuit, 1402: HDD, 1403: input interface device, 1404: output interface device, 1405: CPU, 1406: memory

1. An editing device for editing a first image in a state where an output device is displaying the first image, the editing device comprising:
processing circuitry performing a process of:
displaying a second image corresponding to the first image and an editing component for editing the second image on an image editing screen; and
generating an output image for the output device to display the first image on a basis of the second image by following an operation using the editing component displayed, and when the output device receives information indicating a condition to start display of the first image and being determined by time upon editing the second image, starting outputting the output image to the output device in a case where the condition to start display of the first image is satisfied.

2. The editing device according to claim 1, the process further comprising:
receiving an editing operation of editing the second image; and
restricting editing operations that can be received.

3. The editing device according to claim 1, the process further comprising:
acquiring, as spatial information, an image obtained by capturing a real space in which the first image is displayed,
wherein the process superimposes and displays the second image on the spatial information acquired.

4. An editing device for editing a first image in a state where an output device is displaying the first image, the editing device comprising:
processing circuitry performing a process of:
acquiring spatial information related to a real space in which the first image is displayed;
setting editing guide information related to a structure present in the real space on a basis of the spatial information acquired;
displaying a second image corresponding to the first image, an image based on the editing guide information displayed together with the second image and an editing component for editing the second image on an image editing screen; and
generating an output image for the output device to display the first image on a basis of the second image by following an operation using the editing component displayed, and outputting the output image to the output device,

5. The editing device according to claim 4, the process further comprising:
receiving an editing operation of editing the second image;
restricting editing operations that can be received in a case where the second image and an image based on the editing guide information are moved to a position where the second image and the image overlap by the editing operation received; and
outputting a notification that editing operations that can be received have been restricted by the operation restriction unit.

6. The editing device according to claim 1, the process further comprising:
receiving viewpoint information related to a viewpoint of a viewer who visually recognizes the first image,
wherein the process generates the output image on a basis of the second image and the viewpoint information received.

7. The editing device according to any one of claim 1, the process further comprising:
receiving environmental information related to an environment surrounding the output device,
wherein the process generates the output image on a basis of the second image and the environmental information received.

8. An editing method for editing a first image in a state where an output device is displaying the first image, the editing method comprising:
displaying a second image corresponding to the first image and an editing component for editing the second image on an image editing screen; and
generating an output image for the output device to display the first image on a basis of the second image by following an operation using the editing component displayed, and when the output device receives information indicating a condition to start display of the first image and being determined by time upon editing the second image, starting outputting the output image to the output device in a case where the condition to start display of the first image is satisfied.

9. An editing method for editing a first image in a state where an output device is displaying the first image, the editing method comprising:
acquiring spatial information related to a real space in which the first image is displayed;
setting editing guide information related to a structure present in the real space on a basis of the spatial information acquired;
displaying a second image corresponding to the first image, an image based on the editing guide information displayed together with the second image and an editing component for editing the second image on an image editing screen; and
generating an output image for the output device to display the first image on a basis of the second image by following an operation using the editing component displayed, and outputting the output image to the output device.

10. A tangible, non-transitory storing medium storing an editing program for causing a computer to function as an editing device for editing a first image in a state where an output device is displaying the first image, causing the computer to execute a process of:
displaying a second image corresponding to the first image and an editing component for editing the second image on an image editing screen; and
generating an output image for the output device to display the first image on a basis of the second image by following an operation using the editing component displayed, and when the output device receives information indicating a condition to start display of the first image and being determined by time upon editing the second image, starting outputting the output image to the output device in a case where the condition to start display of the first image is satisfied.

11. A tangible, non-transitory storing medium storing an editing program for causing a computer to function as an editing device for editing a first image in a state where an output device is displaying the first image, causing the computer to execute a process of:
acquiring spatial information related to a real space in which the first image is displayed;
setting editing guide information related to a structure present in the real space on a basis of the spatial information acquired;
displaying a second image corresponding to the first image, an image based on the editing guide information displayed together with the second image and an editing component for editing the second image on an image editing screen; and
generating an output image for the output device to display the first image on a basis of the second image by following an operation using the editing component displayed, and outputting the output image to the output device.

12. An editing system comprising:
an output device for displaying a first image; and
an editing device fir editing the first image in a state where the output device is displaying the first image, the editing device comprising:
a display control unit for displaying a second image corresponding to the first image and an editing component for editing the second image on an image editing screen; and
an output control unit for generating an output image for the output device to display the first image on a basis of the second image by following an operation using the editing component displayed by the display control unit, and when the output device receives information indicating a condition to start display of the first image and being determined by time upon editing the second image, starting outputting the output image to the output device in a case where the condition to start display of the first image is satisfied.

13. An editing system comprising:
an output device for displaying a first image; and
an editing device for editing the first image in a state where the output device is displaying the first image, the editing device comprising:
a real space information acquiring unit for acquiring spatial information related to a real space in which the first image is displayed;
an editing guide setting unit for setting editing guide information related to a structure present in the real space on a basis of the spatial information acquired by the real space information acquiring unit;
a display control unit for displaying a second image corresponding to the first image, an image based on the editing guide information displayed together with the second image and an editing component for editing the second image on an image editing screen; and
an output control unit for generating an output image for the output device to display the first image on a basis of the second image by following an operation using the editing component displayed by the display control unit, and outputting the output image to the output device.
